(19) United States
(12) Patent Application Publication
(10) Pub. No.: US 2015/0271724 A1
(43) Pub. Date: Sep. 24, 2015

(54) SYSTEMS AND METHODS FOR RESPONDING TO A COMMUNICATION EVENT

(71) Applicant: QUALCOMM Incorporated, San Diego, CA (US)

(72) Inventors: Ravi Kanth Kotreka, Hyderabad (IN); Mungal Singh Dhanda, Slough (GB)

(73) Assignee: QUALCOMM Incorporated, San Diego, CA (US)

(21) Appl. No.: 14/223,704

(22) Filed: Mar. 24, 2014

(51) Int. Cl. H04W 36/08; H04W 74/08

(52) U.S. Cl. CPC H04W 36/08; H04W 74/0833

(57) ABSTRACT

A method for responding to a communication event by a wireless communication device is described. The method includes beginning a cell reselection procedure. The method also includes detecting a communication event. The method further includes obtaining at least one system information message required to respond to the communication event. The method additionally includes responding to the communication event before all system information messages are obtained.

### TECHNICAL FIELD

The present disclosure relates generally to communications. More specifically, the present disclosure relates to systems and methods for responding to a communication event.

### BACKGROUND

In the last several decades, the use of electronic devices has become common. In particular, advances in electronic technology have reduced the cost of increasingly complex and useful electronic devices. Cost reduction and consumer demand have proliferated the use of electronic devices such that they are practically ubiquitous in modern society. As the use of electronic devices has expanded, so has the demand for new and improved features of electronic devices. More specifically, electronic devices that perform new functions and/or that perform functions faster, more efficiently or more reliably are often sought after.

Some electronic devices communicate with other electronic devices. These electronic devices may transmit and receive electromagnetic signals. For example, a phone (e.g., a cellular phone, a smartphone, a phone integrated into a vehicle, etc.) may receive signals from a network. For example, the network may relay signals to the electronic device via wireless communication.

However, particular challenges arise in known communications procedures. For example, known procedures can cause electronic devices to function inefficiently or even to become non-responsive. This may lead to degraded performance and/or decreased user satisfaction. As can be observed from this discussion, systems and methods that improve communication procedures may be beneficial.

### SUMMARY

A method for responding to a communication event by a wireless communication device is described. The method includes beginning a cell reselection procedure. The method also includes detecting a communication event. The method further includes obtaining at least one system information message required to respond to the communication event. The method additionally includes responding to the communication event before all system information messages are obtained.

The method may include abandoning reading any other system information message upon obtaining the at least one system information message required to respond to the communication event. The at least one system information message required to respond to the communication event may include Random Access Channel (RACH) control parameters. Responding to the communication event may include initiating a RACH procedure.

The at least one system information message required to respond to the communication event may include an SI3 message. The at least one system information message required to respond to the communication event may include an SI3 message and an SI1 message when hopping is employed.

The communication event may be detected during the cell reselection procedure. The communication event may include at least one of receiving a paging message, initiating mobile terminating (MT) call establishment and initiating mobile originating (MO) call establishment.

A wireless communication device for responding to a communication event is also described. The wireless communication device includes cell reselection circuitry. The cell reselection circuitry is configured to begin a cell reselection procedure, detect a communication event and obtain at least one system information message required to respond to the communication event. The wireless communication device also includes prioritized response circuitry coupled to the cell reselection circuitry. The prioritized response circuitry is configured to respond to the communication event before all system information messages are obtained.

A computer-program product for responding to a communication event is also described. The computer-program product includes a non-transitory tangible computer-readable medium with instructions. The instructions include code for causing a wireless communication device to begin a cell reselection procedure. The instructions also include code for causing the wireless communication device to detect a communication event. The instructions further include code for causing the wireless communication device to obtain at least one system information message required to respond to the communication event. The instructions additionally include code for causing the wireless communication device to respond to the communication event before all system information messages are obtained.

An apparatus for responding to a communication event is also described. The apparatus includes means for beginning a cell reselection procedure. The apparatus also includes means for detecting a communication event. The apparatus further includes means for obtaining at least one system information message required to respond to the communication event. The apparatus additionally includes means for responding to the communication event before all system information messages are obtained.

### BRIEF DESCRIPTION OF THE DRAWINGS

FIG. 1 is a block diagram illustrating one configuration of a wireless communication device in which systems and methods for responding to a communication event may be implemented;

FIG. 2 is a flow diagram illustrating one configuration of a method for responding to a communication event;

FIG. 3 is a block diagram illustrating one example of cell reselection;

FIG. 4 is a thread diagram illustrating one example of a known cell reselection procedure;

FIG. 5 is a thread diagram illustrating one example of a cell reselection procedure in accordance with the systems and methods disclosed herein;

FIG. 6 is a block diagram illustrating a more specific configuration of a wireless communication device in which systems and methods for responding to a communication event may be implemented;

FIG. 7 is a flow diagram illustrating another configuration of a method for responding to a communication event;

FIG. 8 is a flow diagram illustrating another more specific configuration of a method for responding to a communication event;

FIG. 9 is a flow diagram illustrating another more specific configuration of a method for responding to a communication event;

FIG. 10 is a flow diagram illustrating another more specific configuration of a method for responding to a communication event;

FIG. 11 is a block diagram illustrating a Universal Mobile Telecommunication System (UMTS) network operating according to the systems and methods described herein;

FIG. 12 is a block diagram illustrating another more specific configuration of a wireless communication device in which systems and methods for responding to a communication event may be implemented; and

FIG. 13 illustrates certain components that may be included within a wireless communication device.

### DETAILED DESCRIPTION

Some configurations of the systems and methods disclosed herein may provide an improved response (e.g., paging performance) during reselection in wireless communication networks. In some configurations, the systems and methods disclosed herein may be applied in Universal Mobile Telecommunication System (UMTS) networks. However, it is understood that the systems and methods disclosed herein may be equally applied in other suitable communication networks. Some known communication procedures exhibit problems. In particular, known cell reselection procedures may cause a wireless communication device to delay responding to a communication event. For instance, mobile stations may not honor a paging message during an early camped phase or while waiting for a system information (SI) state (e.g., until all the SI messages are read). A communication event may be an event that starts (e.g., begins, triggers, initiates, etc.) communication procedures for transferring information between a cell (e.g., base station, network, etc.) and a wireless communication device. Examples of communication events include paging (e.g., receiving and/or obtaining a paging message from the network), mobile originating (MO) call establishment (in a Global System for Mobile Communications (GSM) system due to circuit-switched fallback (CSFB), for instance) and mobile terminating (MT) call establishment (in a GSM system due to CSFB, for instance).

When executing a cell reselection procedure (e.g., selecting a new paging channel (PCH)), the user equipment (UE) in a GERAN (GSM Enhanced Data rates for GSM Evolution (EDGE) Radio Access Network) system will be in page reorganization mode. In the page reorganization mode, the UE decodes all the paging messages as well as the system information (SI) messages to gain access to the cell. Each of these decoded SI messages serves a varied purpose to the UE or mobile station.

One example of an SI message is an SI3 message. The SI3 message provides the control channel information, Random Access Channel (RACH) control parameters and other information for the mobile station camping procedure and for initiating a RACH procedure.

In one known approach, the UE is unable to act on decoded PCH messages received during this procedure since the UE is in the pursuit of acquiring all the broadcast information (e.g., all SI messages). Acquiring all of the broadcast information may take a long time, depending on the network conditions. During this phase of SI message reception, even after receiving the SI3 message, the UE continues to read the PCH and acquire the unacquired SI messages. This process can last 3 to 10 seconds or even longer. This problem is compounded in multi-subscriber identity module (SIM) devices as the radio frequency (RF) resource is shared across the subscription and might extend this PCH and SI read phase even further. More specifically, a wireless communication device 102 that is a multi-SIM device may have multiple subscriptions associated with each SIM. Each of the multiple subscriptions may share radio frequency (RF) resources (e.g., time and/or frequency resources). The subscriptions may compete for these resources and these resources may be time multiplexed between the multiple subscriptions. For example, if a first SIM misses obtaining an SI message because a second SIM is occupying the resources, a longer delay may result for the first SIM, which may lead to increased cell reselection process time. This may waste time and resources.

Since it is uncertain how long mobile stations may take to complete this PCH and SI read procedure, one known approach saves a paging message received for the mobile station and only acts on it after completing the SI and PCH read procedure. In live networks, the networks are unable to hold the context of a mobile terminating (MT) call for such a long duration. Furthermore, when the mobile terminated mobile station (MS) responds to the paging procedure, the network may reject the response. This leads to poor MT page performance.

The systems and methods disclosed herein provide a solution to the problem described above. In some configurations, when the mobile station enters SI and PCH read phase, the mobile station may act on a communication event (e.g., a paging message received from the network) once the SI3 message is read and/or may abandon reading further SI messages. The systems and methods disclosed herein may offer several benefits or advantages. For example, the systems and methods disclosed herein may enable improved responsiveness (e.g., page performance) and/or improved efficiency (e.g., battery saving) by abandoning additional PCH and SI reading. Additionally, a delayed response (e.g., paging response) may be avoided, thereby avoiding wasting network resources. Furthermore, improved opportunities for other subscriptions to come to a logical state may be provided.

Various configurations are now described with reference to the Figures, where like reference numbers may indicate functionally similar elements. The systems and methods as generally described and illustrated in the Figures herein could be arranged and designed in a wide variety of different configurations. Thus, the following more detailed description of several configurations, as represented in the Figures, is not intended to limit scope, as claimed, but is merely representative of the systems and methods.

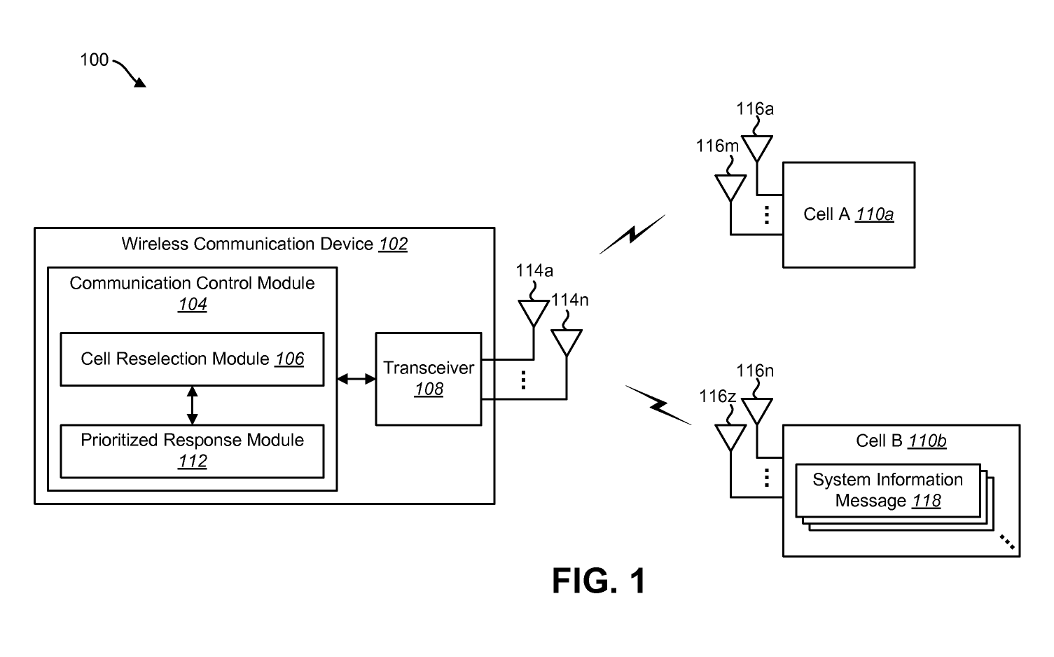

FIG. 1 is a block diagram illustrating one configuration of a wireless communication device 102 in which systems and methods for responding to a communication event may be implemented. The wireless communication device 102 may be included in a wireless communication system 100. The wireless communication system 100 may also include cell A 110a and cell B 110b. Wireless communication systems 100 are widely deployed to provide various types of communication content such as voice, data, and so on. Cell reselection may be performed in the wireless communication system 100 according to the systems and methods described herein.

Cell A 110a and cell B 110b may be provided by separate base stations or by the same base station. The term “cell” can refer to a base station and/or to the coverage area of a base station depending on the context in which the term is used. A base station is a station that may communicate with one or more wireless communication devices 102. A base station may be referred to as and/or may include some or all of the functionality of an access point, a broadcast transmitter, a NodeB, an evolved NodeB, a base transceiver station, etc. Each base station may provide communication coverage for a particular geographic area. A base station may provide communication coverage for one or more wireless communication devices 102. Cell A 110a and/or cell B 110b may include one or more base stations. As illustrated in FIG. 1, cell A 110a (e.g., a first base station) may include one or more antennas 116a-m for communicating with the wireless communication device 102. Additionally, cell B 110b (e.g., a second base station) may include one or more antennas 116n-z for communicating with the wireless communication device 102.

Communications in a wireless system (e.g., a multiple-access system) may be achieved through transmissions over a wireless link. Such a wireless link may be established via a single-input and single-output (SISO), multiple-input and single-output (MISO) or a multiple-input and multiple-output (MIMO) system. A MIMO system includes transmitter(s) and receiver(s) equipped, respectively, with multiple (N_{T}) transmit antennas and multiple (N_{R}) receive antennas for data transmission. In some configurations, the wireless communication system 100 may utilize MIMO. A MIMO system may support time division duplex (TDD) and/or frequency division duplex (FDD) systems.

In some configurations, the wireless communication system 100 may be a multiple-access system capable of supporting communication with multiple wireless communication devices 102 by sharing the available system resources (e.g., bandwidth and transmit power). Examples of such multiple-access systems include code division multiple access (CDMA) systems, wideband code division multiple access (W-CDMA) systems, time division multiple access (TDMA) systems, frequency division multiple access (FDMA) systems, orthogonal frequency division multiple access (OFDMA) systems, evolution-data optimized (EV-DO), single-carrier frequency division multiple access (SC-FDMA) systems, General Packet Radio Service (GPRS) access network systems, 3rd Generation Partnership Project (3GPP) Long Term Evolution (LTE) systems, and spatial division multiple access (SDMA) systems.

The term “network” may refer to wireless communication system 100 infrastructure that enables communication between the wireless communication device 102 and other devices. For example, a network may include one or more cells and/or base stations. A CDMA network may implement a radio technology such as Universal Terrestrial Radio Access (UTRA), cdma2000, etc. UTRA includes W-CDMA and Low Chip Rate (LCR) while cdma2000 covers IS-2000 (CDMA 1X), IS-95, and IS-856 (high rate packet data (HRPD)) standards. A TDMA network may implement a radio technology such as Global System for Mobile Communications (GSM). An OFDMA network may implement a radio technology such as Evolved UTRA (E-UTRA), Institute of Electrical and Electronics Engineers (IEEE) 802.11, IEEE 802.16, IEEE 802.20, Flash-OFDMA, etc. UTRA, E-UTRA, and GSM are part of Universal Mobile Telecommunication System (UMTS). Long Term Evolution (LTE) is a release of UMTS that uses E-UTRA. UTRA, E-UTRA, GSM, UMTS and LTE are described in documents from an organization named “3rd Generation Partnership Project” (3GPP). cdma2000 and Ultra Mobile Broadband (UMB) are described in documents from an organization named “3rd Generation Partnership Project 2” (3GPP2).

The 3rd Generation Partnership Project (3GPP) is a collaboration between groups of telecommunications associations that aims to define a globally applicable 3rd generation (3G) mobile phone specification. 3GPP Long Term Evolution (LTE) is a 3GPP project aimed at improving the Universal Mobile Telecommunications System (UMTS) mobile phone standard. The 3GPP may define specifications for the next generation of mobile networks, mobile systems, and mobile devices.

In 3GPP Long Term Evolution (LTE) and UMTS, a wireless communication device 102 may be referred to as a “user equipment” (UE). In 3GPP Global System for Mobile Communications (GSM), a wireless communication device 102 may be referred to as a “mobile station” (MS). A wireless communication device 102 may also be referred to as and/or may include some or all of the functionality of a terminal, an access terminal, a subscriber unit, a station, etc. Examples of the wireless communication device 102 include cellular phones, smartphones, personal digital assistants (PDAs), wireless devices, wireless modems, handheld devices, laptop computers, Session Initiation Protocol (SIP) phones, wireless local loop (WLL) stations, etc.

A wireless communication device 102 may communicate with zero, one or multiple base stations on the downlink and/or uplink at any given moment. The downlink (or forward link) refers to the communication link from a base station to a wireless communication device 102, and the uplink (or reverse link) refers to the communication link from a wireless communication device 102 to a base station.

The wireless communication device 102 may receive system information from the network (e.g., cell A 110a and/or cell B 110b). For example, cell B 110b may broadcast one or more system information messages 118 to the wireless communication device 102.

If the network receives a call for the wireless communication device 102, the network may send a paging message for the wireless communication device 102 on one or more paging channels. The wireless communication device 102 may receive the paging message on the paging channel. The network may follow additional or alternative procedures for MO call establishment and/or MT call establishment. In some configurations, these procedures may occur during CSFB.

Cell reselection may be performed to maintain and/or improve wireless communication between the wireless communication device 102 and the network. In some configurations, cell reselection may be performed when any of the neighbor cells meet cell reselection criteria based on the system information acquired from the broadcast channel. For example, if the wireless communication device 102 determines that cell power is beyond a certain threshold, the wireless communication device 102 may initiate cell reselection.

In one example, the wireless communication device 102 may determine that another cell reading is better in terms of signal power than the signal power of cell A 110a. For instance, when the wireless communication device 102 is moving from the coverage area of cell A 110a into an area where cell B 110b is better, the wireless communication device 102 may determine that cell B 110b signal power is better and the cell reselection procedure may begin. In some configurations, the wireless communication device 102 may save (e.g., store) received system information (e.g., one or more system information messages 118).

The wireless communication device 102 may determine that it should perform a reselection to cell B 110b from cell A 110a. The wireless communication device 102 may evaluate whether a neighbor cell is a cell reselection candidate based on one or more acquired system information messages 118. For example, upon decoding an SI3 message, the wireless communication device 102 may determine that the cell reselection criteria are met for cell B 110b based on parameters included in the system information. The wireless communication device 102 may initiate a cell reselection from cell A 110a to cell B 110b.

In the known approach as described above, upon the start of a cell reselection process, the wireless communication device 102 is expected to read all the system information (e.g., all of the system information messages 118 in a complete set) on cell B 110b. In the known approach, the wireless communication device 102 may transition to cell B 110b by reading all available system information (e.g., all system information messages 118) on the broadcast channel of cell B 110b. In the cell reselection procedure, the wireless communication device 102 may enter into a page reorganization mode (e.g., PAGE REORG MODE).

In some configurations, one or more system information messages may be required to respond to a communication event (e.g., receiving a paging message, initiating MT call establishment, initiating MO call establishment, etc.). For example, information required to respond to a paging message from cell B 110b may be obtained from a particular system information message 118. In some configurations, the system information message 118 required to respond to a communication event may be a system information type 3 (SI3) message. The one or more system information messages may provide one or more parameters (e.g., control channel parameters, RACH control parameters, etc.) required to respond to the paging message.

The wireless communication device 102 may include a communication control module 104 and a transceiver 108. As used herein, a “module” may be implemented in hardware or in a combination of hardware and software. For example, the communication control module 104 may be implemented in hardware (e.g., circuitry) or in a combination of hardware and software (e.g., processor with instructions).

The communication control module 104 may be coupled to the transceiver 108. As used herein, the term “couple” and variations thereof may denote a direct connection or an indirect connection. For example, the communication control module 104 may be directly connected to the transceiver 108 (without any intervening components) or may be indirectly connected to the transceiver 108 (through one or more intervening components). Lines or arrows in the Figures may indicate a coupling between components.

The transceiver 108 may be coupled to one or more antennas 114a-n. The transceiver 108 may transmit and/or receive signals. For example, the transceiver 108 may transmit one or more messages to cell A 110a and/or cell B 110b via the antenna(s) 114a-n. Additionally or alternatively, the transceiver 108 may receive one or more messages from cell A 110a and/or cell B 110b via the antenna(s) 114a-n.

The communication control module 104 may enable communications between the wireless communication device 102 and cell A 110a and/or cell B 110b. In accordance with the systems and methods disclosed herein, the communication control module 104 may enable a prioritized response to a communication event (during a reselection procedure, for example).

In some configurations, the communication control module 104 may include a cell reselection module 106 and a prioritized response module 112. The cell reselection module 106 may begin a cell reselection procedure. In some configurations, the cell reselection module 106 may initiate the cell reselection procedure. For example, the cell reselection module 106 may determine that the signal strength from cell A 110a is weaker than the signal strength from cell B 110b. Accordingly, the cell reselection module 106 may initiate the cell reselection procedure to transition communications to cell B 110b. In other configurations, the cell reselection module 106 may begin the cell reselection procedure in response to a message from cell A 110a and/or cell B 110b. For example, cell A 110a may initiate the cell reselection procedure by sending a message to the wireless communication device 102 that directs the wireless communication device 102 to begin the cell reselection procedure.

In some configurations, beginning the cell reselection procedure may include entering a page reorganization mode. While in the page reorganization mode, the wireless communication device 102 (e.g., cell reselection module 106) receives and/or decodes one or more system information messages 118 and/or one or more paging messages. The page reorganization mode may correspond to a discontinuous reception (DRX) state and/or to an early camped state.

Upon beginning the cell reselection procedure, the cell reselection module 106 may obtain one or more system information messages 118. Obtaining (e.g., “reading”) a system information message 118 may include receiving and/or decoding the system information message 118. For example, cell B 110b may broadcast the system information messages 118 on a broadcast channel. The cell reselection module 106 may wait for and/or receive one or more of the system information messages 118 (via the antenna(s) 114a-n and transceiver 108). The cell reselection module 106 may decode one or more of the system information messages 118.

The cell reselection module 106 may detect one or more communication events (e.g., receipt of a paging message, initiating MT call establishment and/or initiating MO call establishment). For example, the cell reselection module 106 may obtain one or more paging messages. Obtaining (e.g., “reading”) a paging message may include receiving and/or decoding the paging message. For example, cell B 110b may transmit the paging message(s) on a paging channel (PCH). The cell reselection module 106 may receive the paging message(s) (via the antenna(s) 114a-n and transceiver 108). The cell reselection module 106 may decode the paging message(s). The paging message(s) may indicate that cell B 110b has a pending communication (e.g., phone call, text and/or data download, etc.) for the wireless communication device 102. For example, a paging message may indicate a mobile terminating (MT) call. The paging message may be obtained during the cell reselection procedure.

Additionally or alternatively, the cell reselection module 106 may detect MT call establishment and/or MO call establishment. More specifically, the cell reselection module 106 may detect the initiation of MT call establishment and/or the initiation of MO call establishment, for instance. In one example, the cell reselection module 106 may receive an input (from a user, for example) indicating the initiation of MO call establishment. For instance, the cell reselection module 106 may receive an input (e.g., phone number, “send” or “call” command, etc.) indicating an attempted phone call originating from the wireless communication device 102. The input may be received from a user of the wireless communication device 102. In another example, the cell reselection module 106 may obtain (e.g., receive and/or decode) a message (e.g., a paging message, call request, etc.) indicating the initiation of MT call establishment terminating at the wireless communication device 102. The message may be obtained from the network (e.g., cell B 110b). In some configurations, MT call establishment and/or MO call establishment may occur in the context of CSFB.

For example, circuit-switched fallback (CSFB) may be one of several voice options that have been discussed, proposed and/or standardized to provide voice service to wireless communication devices (e.g., UEs) camped on LTE. In some configurations, voice service may be circuit-switched (CS) based. In CSFB, the wireless communication device 102 (e.g., UE) may fall back to a CS radio access technology (RAT) in certain cases. Voice and/or other CS-domain services (e.g., location services (LCS), CS unrestricted digital information (UDI) video, unstructured supplementary service data (USSD)) may be provided via CSFB in LTE by reusing CS infrastructure when the wireless communication device 102 (e.g., UE) is served by the Evolved UMTS Terrestrial Radio Access Network (E-UTRAN). A wireless communication device 102 that is CS-fallback enabled and that is connected to the E-UTRAN may use the GERAN or the UMTS Terrestrial Radio Access Network (UTRAN) to connect to the CS domain. For example, the wireless communication device 102 may originate normal voice, emergency and/or CS data calls while the wireless communication device 102 (e.g., UE) is camped on LTE. Additionally or alternatively, the wireless communication device 102 may receive normal voice, emergency and/or CS data calls while the wireless communication device 102 (e.g., UE) is camped on LTE. In these cases, the wireless communication device 102 may request CS voice call setup from the network such that the LTE network may enable the wireless communication device 102 (e.g., UE) to move to a CS RAT (e.g., GSM/W-CDMA for 3GPP CSFB and/or CDMA for 1x-CSFB).

It should be noted that the system information message(s) 118 may be obtained and the communication event(s) may be detected in any order during the cell reselection procedure. The systems and methods disclosed herein may be applied in cases where at least one communication event is detected and one or more system information messages 118 required to respond to the communication event(s) are obtained before all of the system information messages 118 (e.g., before every system information message 118 in a complete set). “All of the system information messages” 118 may refer to a complete set of system information messages 118. In some configurations, all of the system information messages may include an SI1 message, an SI2 message, an SI3 message, an SI4 message, an SI7 message, an SI8 message and an SI9 message. For example, the SI5 message and the SI6 message may not be relevant to idle mode or connection establishment from idle mode. In some configurations, an SI13 message, an SI16 message, an SI17 message, an SI21 message and/or an SI23 message may be optionally included in “all of the system information messages” 118 or in the “complete set of system information messages” 118.

The SI1 message may include hopping (e.g., frequency hopping) information. For example, the SI1 message may enable the wireless communication device 102 to employ hopping (e.g., frequency hopping). The SI2 message may include neighbor cell information. The neighbor cell information may indicate one or more cells neighboring the cell that sent the SI2 message. The contents of an SI3 message are described below. For example, the SI3 message may indicate the suitability of the cell from which the SI3 message is received. An SI3 message received from a neighbor cell (e.g., cell B 110b) may indicate that the neighbor cell is available for cell reselection. The SI4 message may include RACH control parameters, cell reselection parameters and/or location area identification. The SI7 message may provide information regarding cell reselection parameters. The SI8 message may provide information regarding cell reselection parameters. The SI9 message may provide scheduling information. The SI13 message may provide GPRS information. The SI16 message may provide cell selection and reselection parameters. The SI17 message may provide cell selection and reselection parameters. The SI21 message may indicate extended access barring (EAB) specific authorized classes and/or may indicate a subcategory of targeted wireless communication devices (e.g., mobile stations). The SI23 message may indicate frequency information related to inter-RAT reselection. It should be noted that the SI13 message, the SI16 message, the SI17 message, the SI21 message and/or the SI23 message may be optional in some configurations. For example, “all of the system information messages” 118 or the “complete set of system information messages 118” may or may not include one or more of the SI13 message, the SI16 message, the SI17 message, the SI21 message and/or the SI23 message.

One or more of the system information messages 118 may be required to respond to the communication event(s). The at least one system information message 118 required to respond to the communication event(s) may be one or more system information messages 118 needed to successfully transmit information to (e.g., raise a call on) a cell (e.g., cell B 110b). For example, one system information message 118 (required to respond to the communication event(s)) may include cell selection parameters. The cell selection parameters may provide information such as whether a cell is suitable for communication with the wireless communication device 102, whether the wireless communication device 102 is allowed to access the cell and/or whether the cell is reserved. This system information message 118 may also include public land mobile network (PLMN) information (e.g., whether the cell belongs to a home network or not). This system information message 118 may also include random access parameters (e.g., RACH control parameters). The random access parameters may indicate information such as when a first random access request (e.g., RACH request) should be sent and/or a power level that should be utilized. In some configurations, this system information message 118 required to respond to the communication event(s) is an SI3 message.

In some configurations, an additional system information message 118 may be required to respond to the communication event(s). For example, a system information message 118 that includes hopping information may be required when hopping is employed (by the network and/or wireless communication system 100, for example). In some configurations, the additional system information message 118 required to respond to the communication event(s) is an SI1 message. Accordingly, the at least one system information message required to respond to the communication event(s) may include an SI3 message and an SI1 message when hopping is employed. If hopping is not employed, only one system information message (e.g., the SI3 message) may be required.

In some configurations, the cell reselection module 106 may abandon reading (e.g., receiving and/or decoding) any other system information message 118 upon obtaining the at least one system information message 118 required to respond to the communication event. For example, the cell reselection module 106 may stop receiving and/or decoding any remaining system information message(s) 118. In some configurations, the cell reselection module 106 may stop reading any other system information message(s) 118 once the communication event(s) are detected and the system information message(s) 118 required to respond to the communication event(s) are received (and identified), even though the system information message(s) 118 required to respond to the communication event(s) (and/or the paging message(s)) are not fully decoded yet. In other configurations, the cell reselection module 106 may stop reading any other system information message(s) 118 once the system information message(s) 118 required to respond to the communication event(s) (and/or the paging message(s)) are fully decoded.

As described above, each SI message may have a purpose for the wireless communication device 102 (e.g., UE). However, as long as the wireless communication device 102 makes a voice call, only the SI3 message is needed (and possibly the SI1 message if hopping is employed). Accordingly, the wireless communication device 102 may proceed with the connection establishment procedure in order to decrease the time the wireless communication device 102 (e.g., UE) takes compared to the conventional approach. As described above, some SI messages may provide GPRS information and so on and so forth. It should be noted that by not reading the complete set of SI messages 118 and proceeding with connection establishment procedure, the wireless communication device 102 (e.g., UE) may not be handicapped.

Abandoning reading any other system information message 118 may include directing the transceiver 108 to stop receiving any other system information message 118. For example, the cell reselection module 106 may cause the transceiver 108 (by sending an indicator or directive to the transceiver 108, for example) to de-tune from the broadcast channel of cell B 110b. Additionally or alternatively, abandoning reading any other system information message 118 may include discontinuing decoding any other system information message 118. Additionally or alternatively, abandoning reading any other system information message 118 may include exiting or ending page reorganization mode and/or entering a dedicated mode. Accordingly, abandoning reading any other system information message may reduce the time spent waiting for system information reception (e.g., in page reorganization mode).

The cell reselection module 106 may be coupled to the prioritized response module 112. In some configurations, the cell reselection module 106 may notify the prioritized response module 112 when one or more communication events (e.g., paging message, MT call establishment, MO call establishment) are detected and/or when the system information message(s) 118 required to respond to the communication event(s) are obtained. Additionally or alternatively, the cell reselection module 106 may notify the prioritized response module 112 regarding when responding to the communication event(s) is allowed.

The prioritized response module 112 may respond to the communication event(s) before all system information messages 118 are obtained. For example, if at least the system information message(s) 118 required to respond to the communication event(s) are obtained, the prioritized response module 112 may respond to the communication event(s) before all of the system information messages 118 are obtained. More specifically, if the SI3 message (or the SI3 and SI1 messages if hopping is employed) is received and/or decoded, the prioritized response module 112 may respond to the paging message(s), initiation of MT call establishment and/or initiation of MO call establishment before the complete set of SI messages 118 is obtained. Responding to the communication event(s) may include following procedures for receiving payload information from and/or transmitting payload information to the network (e.g., cell B 110b). For example, responding to the paging message(s) may include raising a call with the network.

In some configurations, responding to the communication event(s) includes initiating a random access procedure (with cell B 110b, for instance). For example, responding to the communication event(s) may include initiating a RACH procedure. Initiating the random access procedure may include sending a random access request to cell B 110b. In some configurations, responding to the communication event(s) includes exiting the page reorganization mode and/or entering a dedicated mode. Responding to the paging message(s) as described herein may avoid the loss of a paging message context. For example, the systems and methods disclosed herein may enable responding to a paging message within an amount of time before a paging message context is lost. Additionally or alternatively, responding to the communication event(s) as described herein may include not delaying responding to a communication event and/or prioritizing the communication event response (over receiving other system information messages, for example).

It should be noted that other configurations of the communication control module 104 may be implemented in accordance with the systems and methods disclosed herein. For example, the communication control module 104 may include fewer or more modules than those depicted in FIG. 1. Accordingly, the functions and/or procedures described in connection with the cell reselection module 106 and/or the prioritized response module 112 may be performed by fewer or more modules than the cell reselection module 106 and/or the prioritized response module 112.

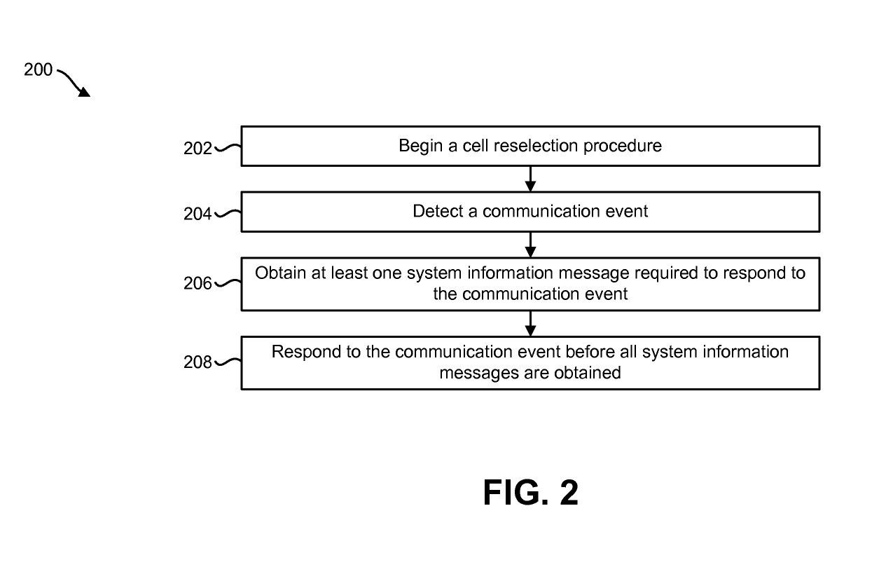

FIG. 2 is a flow diagram illustrating one configuration of a method 200 for responding to a communication event. The method 200 may be performed by the wireless communication device 102. The wireless communication device 102 may begin 202 a cell reselection procedure. This may be accomplished as described above in connection with FIG. 1. For example, the wireless communication device 102 or a cell (e.g., cell A 110a) may initiate the cell reselection procedure. Beginning the cell reselection procedure may include entering a page reorganization mode.

The wireless communication device 102 may detect 204 one or more communication events. This may be accomplished as described above in connection with FIG. 1. For example, the wireless communication device 102 may obtain (e.g., receive and/or decode) one or more paging messages from a cell (e.g., cell B 110b). Additionally or alternatively, the wireless communication device 102 may detect MT call establishment (due to CSFB in a GSM system, for example) and/or may detect MO call establishment (due to CSFB in a GSM system, for example). The communication event(s) may be detected 204 during the cell reselection procedure.

The wireless communication device 102 may obtain 206 at least one system information message 118 required to respond to the communication event(s). This may be accomplished as described above in connection with FIG. 1. For example, obtaining 206 a system information message 118 required to respond to the communication event(s) may include receiving and/or decoding one or more system information messages 118 that are needed for the wireless communication device 102 to respond to the communication event(s). In some configurations, one system information message may be required. This system information message may include cell selection parameters and/or random access parameters. This system information message may also include information regarding whether a cell is suitable for communication, whether cell access is allowed, whether the cell is reserved and/or whether the cell belongs to a home network. In some configurations, this system information message 118 required to respond to the communication event(s) is an SI3 message. It should be noted that the at least one system information message required to respond to the communication event may be obtained 206 before, during or after detecting 204 the communication event(s).

In some configurations, the at least one system information message 118 required to respond to the communication event(s) may include an additional system information message 118. For example, an additional system information message 118 that includes hopping information may be required when hopping is employed (by the network and/or wireless communication system 100, for example). In some configurations, the additional system information message 118 required to respond to the communication event(s) is an SI1 message. As described above, the at least one system information message required to respond to the communication event(s) may include an SI3 message and an SI1 message when hopping is employed. If hopping is not employed, only one system information message (e.g., the SI3 message) may be required.

The system information message(s) 118 required to respond to the communication event(s) may be referred to as “required system information message(s).” Other system information messages 118 may be referred to as “non-required system information message(s).” The required system information message(s) 118 may be received and/or decoded before all of the system information messages 118. In one scenario, the required system information message(s) 118 may be received and/or decoded before any non-required system information messages 118. In another scenario, the required system information message(s) 118 may be received and/or decoded after one or more non-required system information messages but before all of the system information messages 118. In cases where there are multiple required system information messages 118 (e.g., SI3 and SI1 messages), the required system information messages 118 may be received and/or decoded consecutively or non-consecutively.

It should be noted that the required system information message(s) 118 may be obtained 206 and the communication event(s) may be detected 204 in any order. The systems and methods disclosed herein may be applied in cases where a communication event is detected 204 and one or more required system information messages 118 are obtained 206 before all of the system information messages 118.

The wireless communication device 102 may respond 208 to the communication event(s) before all system information messages 118 are obtained (e.g., before obtaining each and every system information message 118 in a complete set). This may be accomplished as described above in connection with FIG. 1. For example, if at least the required system information message(s) 118 (e.g., SI3 message or SI1 and SI3 messages) are obtained, the wireless communication device 102 may respond 208 to the communication event(s) before all of the system information messages 118 are obtained. Responding 208 to the communication event(s) may include following procedures for receiving payload information from and/or transmitting payload information to the network (e.g., cell B 110b). In some configurations, responding 208 to the communication event(s) includes initiating a random access procedure (with cell B 110b, for instance). For example, responding 208 to the communication event(s) may include initiating a RACH procedure. Initiating the random access procedure may include sending a random access request (to cell B 110b, for example).

In some configurations, the wireless communication device 102 may perform payload communication based on responding 208 to the communication event(s). For example, the wireless communication device 102 may receive an immediate assignment (IA). The wireless communication device 102 may transmit and/or receive payload information.

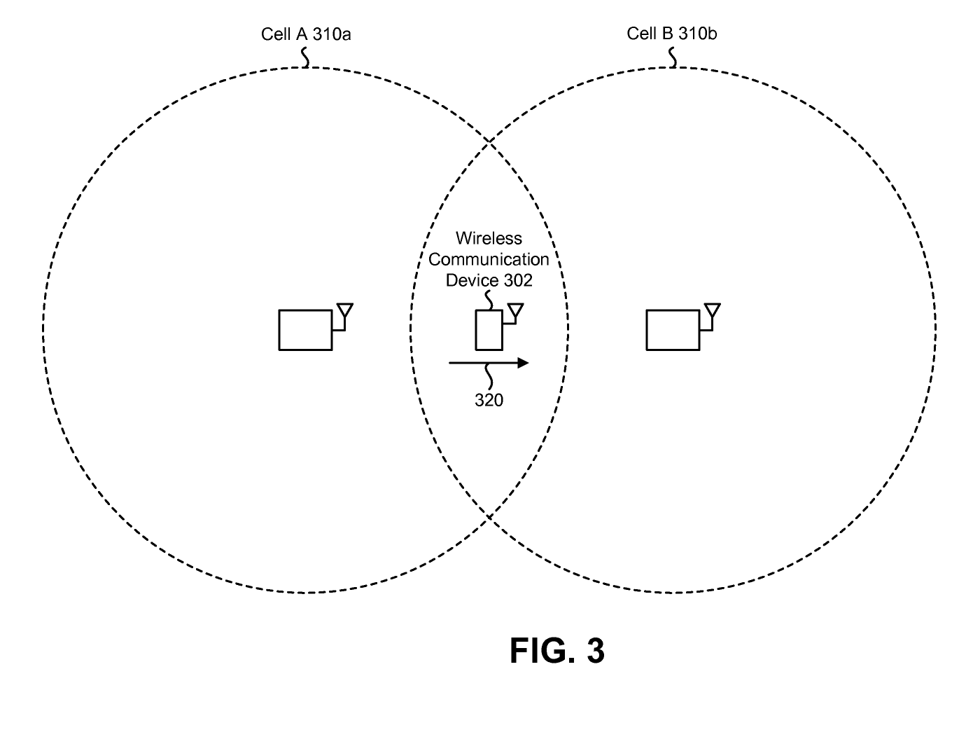

FIG. 3 is a block diagram illustrating one example of cell reselection. In particular, FIG. 3 depicts cell A 310a and cell B 310b. Cell A 310a described in connection with FIG. 3 may be one example of cell A 110a described in connection with FIG. 1. Additionally, cell B 310b described in connection with FIG. 3 may be one example of cell B 110b described in connection with FIG. 1. As shown in FIG. 3, cell A 310a and cell B 310b may have overlapping coverage areas. A wireless communication device 302 is also depicted in FIG. 3. The wireless communication device 302 described in connection with FIG. 3 may be one example of the wireless communication device 102 described in connection with FIG. 1.

The wireless communication device 302 may be initially camped on cell A 310a. The term “camp” refers to a state in which the wireless communication device 302 monitors a cell for system information and paging information. Accordingly, the wireless communication device 302 may initially receive paging information on a paging channel of cell A 310a. For example, while in idle mode, the wireless communication device 302 may be tuned to the paging channel of cell A 310a. The wireless communication device 302 may also initially receive system information message(s) on a broadcast channel of cell A 310a.

While camped on cell A 310a, the wireless communication device 302 may monitor the broadcast channel of the neighbor cells (e.g., cell B 310b) to determine whether to perform a cell reselection. During this process, the wireless communication device 302 may verify if the network (e.g., the PLMN) of a neighbor cell matches with the current camped cell A 310a by decoding a system information message (e.g., an SI3 message or an SI4 message).

While monitoring the neighbor cells, the wireless communication device 302 may evaluate cell reselection parameters obtained from the neighbor cells (e.g., cell B 310b). The wireless communication device 302 may determine that cell B 310b meets cell reselection criteria and may begin a cell reselection procedure. For example, the wireless communication device 302 may initiate cell reselection 320 to cell B 310b.

The wireless communication device 302 may detect one or more communication events (e.g., receive one or more paging messages) from cell B 310b during cell reselection 320. For example, the wireless communication device 302 may receive one or more paging messages on one or more common control channels (CCCHs). The wireless communication device 302 may respond to the communication event(s) before obtaining all of the system information messages from cell B 310b. In some configurations, the wireless communication device 302 may abandon reading any other (non-required) system information messages.

In some configurations, the wireless communication device 302 (e.g., UE) may not need to decode any SI message on cell B 310b for decoding the paging channel on that cell. When in reselection, the wireless communication device 302 may be in pursuit of all SI messages and may also be decoding all common control channels (CCCH) on that cell, including the broadcast control channel (BCCH). By virtue of reading all CCCHs, the wireless communication device 302 (e.g., UE) may obtain a potential page for itself.

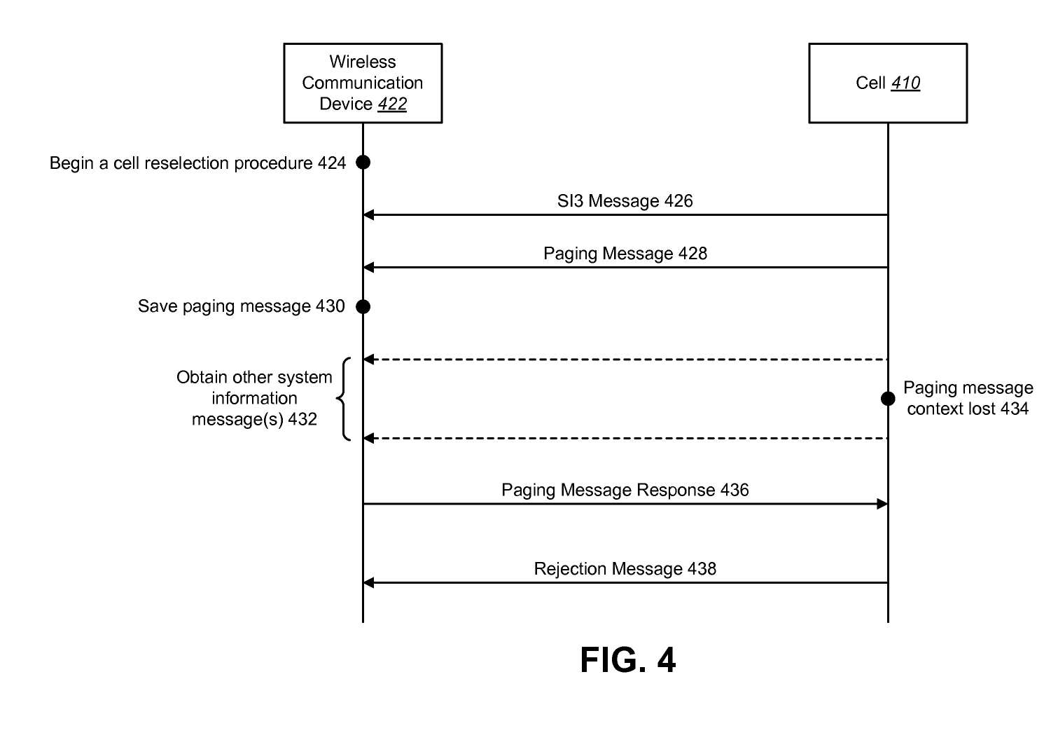

FIG. 4 is a thread diagram illustrating one example of a known cell reselection procedure. In particular, FIG. 4 depicts a wireless communication device 422 and a cell 410. The wireless communication device 422 may begin 424 a cell reselection procedure.

The wireless communication device 422 may obtain an SI3 message 426 from the cell 410. The SI3 message 426 may provide information for responding to the paging message of the cell 410. It should be noted that the SI3 message may not provide any information about the PCH per se. However, the SI3 message may indicate how many of the common control channels (CCCHs) have paging information in them. During cell reselection, however, the wireless communication device 422 (e.g., UE) may read all CCCHs irrespective of what is broadcast in the SI3 message.

The wireless communication device 422 may also obtain a paging message 428. In the known cell reselection procedure, if the wireless communication device 422 has not obtained all of the system information messages, the wireless communication device saves 430 the paging message 428. For example, the paging message 428 may be saved 430 (e.g., stored) until all of the system information messages are obtained.

The wireless communication device 422 may obtain 432 one or more other system information messages. For example, the wireless communication device 422 may then obtain 432 (e.g., receive and decode) all other system information messages (e.g., system information blocks) from the broadcast channel of the cell 410. It should be noted that although obtaining 432 the other system information messages has been grouped for convenience in FIG. 4, the paging message 428 may be obtained in any order relative to the system information messages.

A problem may arise when the paging message 428 is obtained at any time before all of the system information messages have been obtained. In this case, the wireless communication device 422 may save 430 the paging message 428 until all of the system information messages have been obtained, even if the SI3 message 426 has also been obtained.

In some cases, delaying a paging message response 436 may cause the cell 410 to lose 434 the paging message context. Specifically, the paging message context may be lost 434 while the wireless communication device 422 delays responding to the paging message 428 to obtain all of the system information messages. For example, the cell 410 may obtain or be notified of an incoming call for the wireless communication device 422 while the wireless communication device 422 is performing the cell reselection procedure (e.g., in page reorganization mode). Accordingly, the cell 410 may send the paging message 428 to the wireless communication device 422. However, the cell 410 may not be able to hold the incoming call context until the wireless communication device 422 obtains all of the system information messages. Accordingly, the paging message context may be lost 434. In this scenario, the delay may cause an abnormal and/or unspecified channel release.

Once the wireless communication device 422 has obtained all of the system information messages, the wireless communication device 422 may send a paging message response 436 to the cell 410. By that time, the cell 410 may have lost 434 the paging message context. Accordingly, the cell 410 may send a rejection message 438 to the wireless communication device 422.

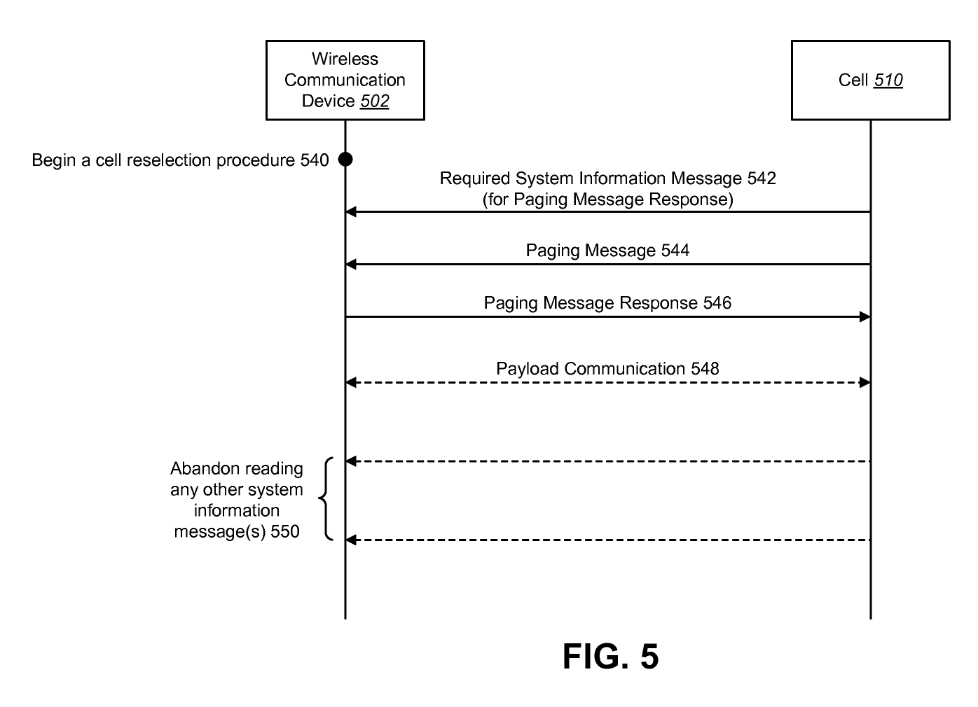

FIG. 5 is a thread diagram illustrating one example of a cell reselection procedure in accordance with the systems and methods disclosed herein. In particular, FIG. 5 depicts a wireless communication device 502 and a cell 510. The wireless communication device 502 may begin 540 a cell reselection procedure as described above in connection with one or more of FIGS. 1-3.

The wireless communication device 502 may obtain a required system information message 542 (e.g., an SI3 message) for a paging message response from the cell 510. This may be accomplished as described above in connection with one or more of FIGS. 1-3. The required system information message 542 may provide information for responding to the paging message 544 from the cell 510.

The wireless communication device 502 may also obtain a paging message 544. In accordance with the systems and methods disclosed herein, the wireless communication device 502 may respond to the paging message 544 before all system information messages are obtained. For example, the wireless communication device 502 may send a paging message response 546. For instance, the wireless communication device 502 may send a random access request or initiate a RACH procedure.

The paging message response 546 may establish payload communication 548 between the cell 510 and the wireless communication device 502. This may avoid losing the context of the paging message as described in connection with FIG. 4. For example, the wireless communication device 502 may receive a phone call, text and/or download data from the cell 510 based on the paging message response 546.

The wireless communication device 502 may abandon 550 reading any other system information message(s). This may be accomplished as described above in connection with FIG. 1. For example, the wireless communication device 102 may abandon 550 reading (e.g., receiving and/or decoding) any other system information message upon obtaining the at least one required system information message 542 for a paging message response. For instance, the wireless communication device 102 may stop receiving and/or decoding any remaining system information message(s) 118.

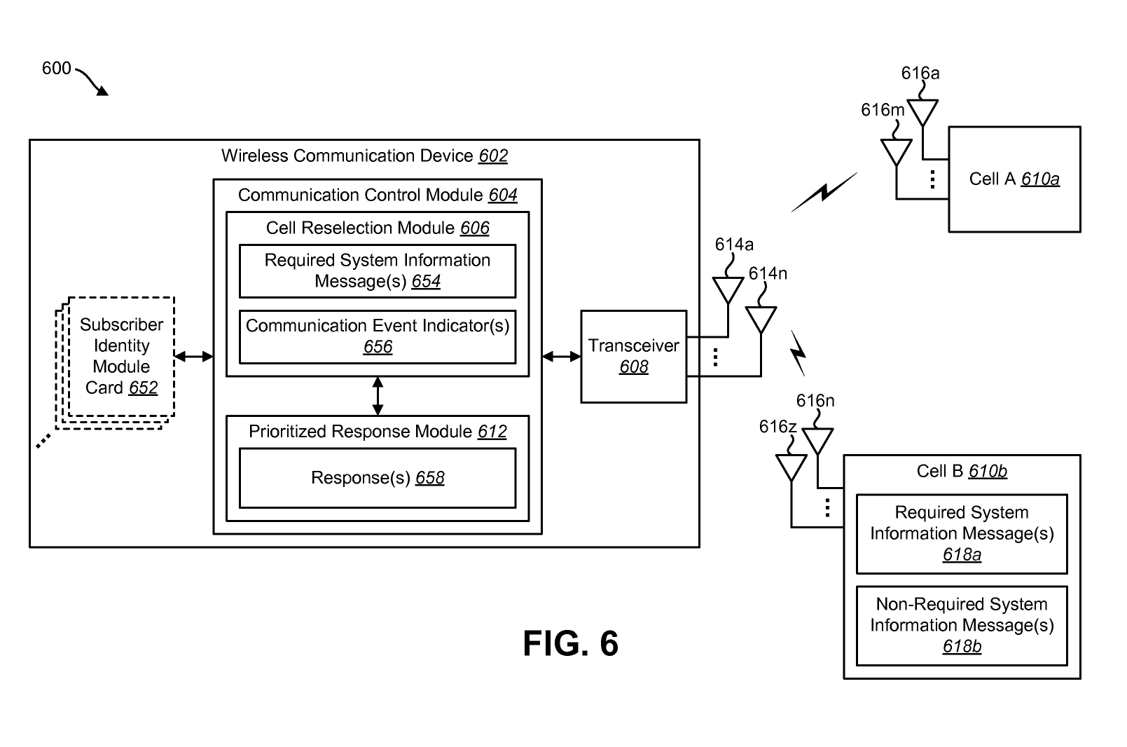

FIG. 6 is a block diagram illustrating a more specific configuration of a wireless communication device 602 in which systems and methods for responding to a communication event may be implemented. The wireless communication device 602 may be one example of the wireless communication device 102 described in connection with FIG. 1. The wireless communication device 602 may be included in a wireless communication system 600, which may be an example of the wireless communication system 100 described in connection with FIG. 1. The wireless communication system 600 may also include cell A 610a and cell B 610b, which may be examples of cell A 110a and cell B 110b described in connection with FIG. 1, respectively. Cell reselection may be performed in the wireless communication system 600 according to the systems and methods described herein.

The cells 610a-b may provide communication coverage for one or more wireless communication devices 602. As illustrated in FIG. 6, cell A 610a (e.g., a first base station) may include one or more antennas 616a-m for communicating with the wireless communication device 602. Additionally, cell B 610b (e.g., a second base station) may include one or more antennas 616n-z for communicating with the wireless communication device 602.

The wireless communication device 602 may receive system information from the network (e.g., cell A 610a and/or cell B 610b). For example, cell B 610b may broadcast one or more system information messages 618 to the wireless communication device 602. As described above, the system information messages 618 may include required system information messages 618a and non-required system information messages 618b. The required system information message(s) 618a may include one or more system information messages required to respond to a communication event. In some configurations (where hopping is not employed, for example), the required system information message(s) 618a may include only an SI3 message. In these configurations, the non-required system information messages 618b may include all other system information messages, including the SI1 message. In other configurations (where hopping is employed, for example), the required system information messages 618a may include both the SI3 message and the SI1 message. In these configurations, the non-required system information messages 618b may include all other system information messages. Cell B 610b may broadcast both the required system information message(s) 618a and the non-required system information message(s) 618b.

As described above, cell reselection may be performed to maintain and/or improve wireless communication between the wireless communication device 602 and the network (e.g., cell A 610a and/or cell B 610b). The wireless communication device 602 may begin the cell reselection procedure, where the cell reselection procedure may be initiated by the wireless communication device 602 or by one or more cells 610a-b as described above.

The wireless communication device 602 may include one or more subscriber identity module (SIM) cards 652. The SIM card(s) 652 may include information for one or more subscriptions. For example, the information included in the SIM card(s) 652 may provide subscription information for the wireless communication device 602 to authenticate and/or to receive service from a service provider network (e.g., cells 610a-b). In some configurations, multiple subscriptions from the SIM card(s) 652 may be used concurrently. In these configurations, the subscriptions may share the RF resources of the wireless communication device 602.

In the known approach as described above, utilizing multiple subscriptions may delay reception of the system information messages 618a-b. For example, if a subscription (of a first SIM card 652) is occupying RF resources at the time when cell B 610b is broadcasting system information message(s) 618a-b for a second subscription (of a second SIM card 652) in cell reselection mode, the second subscription may miss reception of one or more of the system information messages 618a-b. In this case, the second subscription may have to wait until cell B 610b broadcasts the missed system information message(s) 618a-b when the second subscription has access to the RF resources and can receive the missed system information message(s). This is because the wireless communication device 602 is expected to read all the system information messages 618 on cell B 610b in the cell reselection procedure in the known approach. Thus, reading all of the system information messages 618 according to the known approach may be delayed. In one example, this may delay a response to a paging message received during cell reselection, which may cause a cell (e.g., cell B 610b) to lose the context for the paging message.

The wireless communication device 602 may include a communication control module 604 and a transceiver 608. The communication control module 604 and the transceiver 608 described in connection with FIG. 6 may be examples of the communication control module 104 and the transceiver 108 described above in connection with FIG. 1, respectively.

The communication control module 604 may be coupled to the transceiver 608. The transceiver 608 may be coupled to one or more antennas 614a-n. The transceiver 608 may transmit and/or receive signals. For example, the transceiver 608 may transmit one or more messages to cell A 610a and/or cell B 610b via the antenna(s) 614a-n. Additionally or alternatively, the transceiver 608 may receive one or more messages from cell A 610a and/or cell B 610b via the antenna(s) 614a-n.

The communication control module 604 may enable communications between the wireless communication device 602 and cell A 610a and/or cell B 610b. In accordance with the systems and methods disclosed herein, the communication control module 604 may enable a prioritized response during a reselection procedure.

In some configurations, the communication control module 604 may include a cell reselection module 606 and a prioritized response module 612. The cell reselection module 606 may begin a cell reselection procedure, which may be initiated by the cell reselection module 606 or by a cell (e.g., cell A 610a and/or cell B 610b). Beginning the cell reselection procedure may include entering a page reorganization mode. While in the page reorganization mode, the wireless communication device 602 (e.g., cell reselection module 606) receives and/or decodes one or more system information messages 618 (and/or one or more paging messages, for instance).

During the cell reselection procedure, the cell reselection module 606 may obtain one or more system information messages 618. For example, cell B 610b may broadcast the system information messages 618 on a broadcast channel. The cell reselection module 606 may receive and/or decode one or more of the system information messages 618. In particular, the cell reselection module 606 may obtain (e.g., receive and/or decode) one or more required system information messages 654. The one or more required system information messages 654 may be required to respond to one or more communication event(s) as described above. For example, the one or more required system information messages 654 may include only an SI3 message in some configurations or may include both an SI3 and an SI1 message in other configurations (when hopping is employed, for example).

The cell reselection module 606 may detect one or more communication events (e.g., receipt of a paging message, initiating MT call establishment and/or initiating MO call establishment). This may be accomplished as described above in connection with FIG. 1. In some configurations, the cell reselection module 606 may detect the communication event(s) based on one or more communication event indicators 656. Examples of communication event indicators 656 include paging messages, information indicating MT call establishment (e.g., a call request, a paging message, etc.) and information indicating MO call establishment (e.g., a call or send command, a phone number, etc.). For example, the cell reselection module 606 may obtain (e.g., receive and/or decode) one or more paging messages during the cell reselection procedure. Cell B 610b may transmit the paging message(s) on a paging channel (PCH), which may be obtained by the cell reselection module 606.

In some configurations, the cell reselection module 606 may abandon reading (e.g., receiving and/or decoding) any other system information message 618 upon obtaining the required system information message(s) 654. For example, the cell reselection module 606 may stop receiving and/or decoding any non-required system information message(s) 618b. In some configurations, the cell reselection module 606 may stop receiving and/or decoding any of the non-required system information message(s) 618b that have not already been received and/or decoded at the time the required system information message(s) 654 have been received and/or decoded. Additionally or alternatively, obtaining (e.g., reading, receiving and/or decoding) the non-required system information message(s) 618b may be conditioned upon when a communication event is detected. For example, if the required system information message(s) 654 have been obtained (e.g., received and/or decoded) but a communication event has not yet been detected, the cell reselection module 606 may continue to obtain (e.g., read, receive and/or decode) one or more non-required system information messages 618b until a communication event is detected. Once a communication event is detected, the cell reselection module 606 may abandon reading any non-required system information messages 618b. More specifically, the cell reselection module 606 may determine when both the required system information message(s) 654 and at least one communication event is detected and may abandon reading any non-required system information messages 618b that have not already been received and/or decoded.

In some configurations, the cell reselection module 606 may stop reading any other system information message(s) 618 once the communication event(s) are detected and the system information message(s) 618a required to respond to the communication event(s) are received (and identified), even though the system information message(s) 618a required to respond to the communication event (and/or the paging message(s)) are not fully decoded yet. In other configurations, the cell reselection module 606 may stop reading any other system information message(s) 618b once the required system information message(s) 654 (and/or the paging message(s)) are fully decoded.

In other configurations, the cell reselection module 606 may determine whether to abandon reading any remaining non-required system information message(s) 618b that have not been already obtained based on one or more additional or alternative factors. These factors may include the type of page (e.g., whether it is for a phone call, text or data download), an amount of time before anticipated context loss, how many non-required system information message(s) 618b remain (of a complete set), when the next broadcast of system information messages 618 is anticipated, an (estimated) amount of reading time (e.g., reception and/or decoding time) required, whether multiple subscriptions (corresponding to the SIM cards 652) are active, whether another subscription (besides the subscription in the cell reselection procedure) is occupying the RF resources and the amount of time anticipated for the other subscription to occupy the RF resources.

In some configurations, assuming that the required system information message(s) 654 have been obtained and at least one communication event has been detected, the cell reselection module 606 may determine whether to abandon reading any remaining non-required system information message(s) 618b (and/or whether to delay responding to the communication event(s)) based on one or more additional factors as follows. The cell reselection module 606 may abandon reading if the page type is for a phone call (and may not if the page type is for a text message or data download, for example). Additionally or alternatively, the cell reselection module 606 may abandon reading if an anticipated broadcast of system information is not within a threshold amount of time (e.g., a predetermined threshold amount of time or an amount of time before anticipated context loss minus estimated reading time). Additionally or alternatively, the cell reselection module 606 may abandon reading if the number of remaining non-required system information message(s) 618b cannot be read within a threshold amount of time (or may not be read within a threshold amount of time with some probability, for example). Additionally or alternatively, the cell reselection module 606 may abandon reading if the cell reselection module 606 estimates that the number of remaining non-required system information message(s) 618b may not be read within a time before a particular time or anticipated context loss (with some probability threshold, for example). Additionally or alternatively, the cell reselection module 606 may abandon reading if another subscription is active. Additionally or alternatively, the cell reselection module 606 may abandon reading if the other subscription is occupying RF resources during an anticipated system information message 618 broadcast. Determining whether to abandon reading the remaining non-required system information message(s) 618b may be based on any of the foregoing individual factors or based on any combination thereof.

In one configuration, the cell reselection module 606 may determine whether the paging message is for a phone call or not. If the paging message is not for a phone call (e.g., an MT call), the cell reselection module 606 may read all of (e.g., not abandon reading) the non-required system information messages 618b. If the paging message is for a phone call, the cell reselection module 606 may determine whether reading the remaining non-required system information message(s) 618b may be completed before an anticipated context loss. This determination may be based on the number (and/or type) of remaining non-required system information message(s) 618b, the reading (e.g., decoding) time for each of the remaining non-required system information message(s) 618b, whether another subscription is active (and whether it is occupying RF resources and/or an amount of time it is scheduled to occupy the RF resources), the one or more anticipated non-required system information message 618b broadcast times and/or an anticipated time for context loss. The cell reselection module 606 may take one or more of these factors into account. For example, if another subscription is scheduled to de-occupy RF resources when an anticipated broadcast of non-required system information message(s) 618b will occur, if the number and type of remaining non-required system information message(s) 618b may be obtained and if a paging response may be sent to cell B 610b before the anticipated context loss, the cell reselection module 606 may obtain the remaining non-required system information message(s) 618b (and/or may delay responding to the paging message). Otherwise, the cell reselection module 606 may abandon reading any remaining non-required system information message(s) 618b (and/or may not delay responding to the paging message).

In some configurations, this determination may be based on a probability. For example, if the remaining non-required system information message(s) 618b may be obtained with some probability of success, then the cell reselection module 606 may obtain the remaining non-required system information message(s) 618b (and/or may delay responding to the communication event (e.g., paging message)). Otherwise, the cell reselection module 606 may abandon reading any remaining non-required system information message(s) 618b (and/or may not delay responding to the communication event).

In some configurations, the cell reselection module 606 may determine that only one or more remaining non-required system information message(s) 618, but not all, may be obtained before a particular time or an anticipated context loss. The cell reselection module 606 may then obtain only the one or more remaining non-required system information message(s) 618b that can be obtained before the particular time and/or without causing a context loss. In this approach, for example, the cell reselection module 606 may delay responding to a paging message but may then respond before the context is lost.

Abandoning reading any remaining non-required system information message 618b may include directing the transceiver 608 to stop receiving any other system information message 618. Additionally or alternatively, abandoning reading any remaining non-required system information message 618b may include discontinuing decoding any other system information message 618.

The cell reselection module 606 may be coupled to the prioritized response module 612. In some configurations, the cell reselection module 606 may notify the prioritized response module 612 when one or more communication events are detected and/or when the system information message(s) 654 required to respond to the communication event(s) are obtained. Additionally or alternatively, the cell reselection module 606 may notify the prioritized response module 612 regarding when responding to the communication event(s) is allowed.

The prioritized response module 612 may respond to the communication event(s). For example, if at least the required system information message(s) 654 are obtained, the prioritized response module 612 may send one or more response(s) 658 (e.g., paging message responses, control information, access requests, etc.). In some configurations, responding to the communication event(s) includes initiating a random access procedure (with cell B 610b, for instance). For example, responding to the communication event(s) may include initiating a RACH procedure. In some configurations, the prioritized response module 612 may delay sending the response(s) 658 until the cell reselection module 606 indicates that responding to the communication event(s) is allowed.

It should be noted that other configurations of the communication control module 604 may be implemented in accordance with the systems and methods disclosed herein. For example, the communication control module 604 may include fewer or more modules than those depicted in FIG. 6. Accordingly, the functions and/or procedures described in connection with the cell reselection module 606 and/or the prioritized response module 612 may be performed by fewer or more modules than the cell reselection module 606 and/or the prioritized response module 612. It should also be noted that any of the functions and/or procedures described in connection with FIG. 6 may be performed as part of a method.

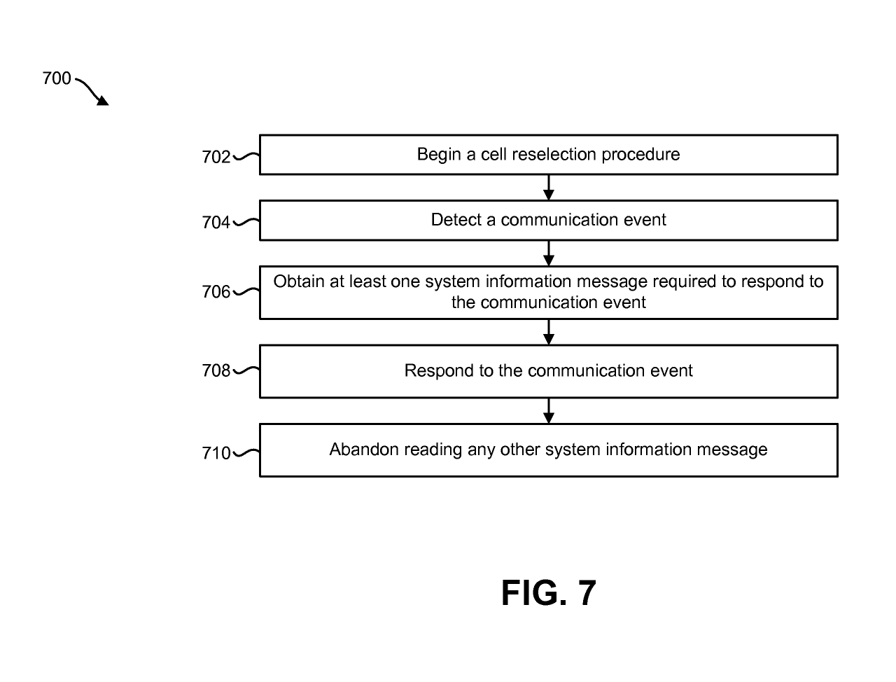

FIG. 7 is a flow diagram illustrating another configuration of a method 700 for responding to a communication event. The method 700 may be performed by the wireless communication device 602. The wireless communication device 602 may begin 702 a cell reselection procedure. This may be accomplished as described above in connection with one or more of FIGS. 1-3 and 5-6. For example, the wireless communication device 602 or a cell (e.g., cell A 610a) may initiate the cell reselection procedure. Beginning 702 the cell reselection procedure may include entering a page reorganization mode.

The wireless communication device 602 may detect 704 one or more communication events. This may be accomplished as described above in connection with one or more of FIGS. 1-3 and 5-6. For example, the wireless communication device 602 may obtain (e.g., receive and/or decode) one or more paging messages from a cell (e.g., cell B 610b). Additionally or alternatively, the wireless communication device 602 may detect MT call establishment (due to CSFB in a GSM system, for example) and/or may detect MO call establishment (due to CSFB in a GSM system, for example). The communication event(s) may be detected 704 during the cell reselection procedure.

The wireless communication device 602 may obtain 706 at least one system information message 618a required to respond to the communication event(s) (e.g., required system information message(s) 654). This may be accomplished as described above in connection with one or more of FIGS. 1-3 and 5-6. As described above, one or more system information messages may be required. For example, the required system information messages 654 may include an SI3 message or SI3 and SI1 messages (when hopping is employed, for example). It should be noted that the required system information message(s) 654 may be obtained 706 before detecting 704 the communication event(s) in some configurations.

The wireless communication device 602 may respond 708 to the communication event(s). This may be accomplished as described above in connection with one or more of FIGS. 1-3 and 5-6. In some configurations, the wireless communication device 602 may respond 708 to the communication event (s) before all system information messages 618 (e.g., before all non-required system information messages 618b) are obtained. For example, if the SI3 message (or the SI3 and SI1 messages if hopping is employed) is received and/or decoded, the wireless communication device 602 may respond to the communication event (s) before the complete set of SI messages 618 is obtained.

In other configurations, the wireless communication device 602 may respond 708 to the communication event(s) before all non-required system information messages 618b if not all non-required system information messages 618b can be obtained before a particular time or before losing a paging message context. For example, the wireless communication device 602 may determine whether one or more remaining non-required system information messages 618b may be obtained without losing the paging message context. This may be accomplished as described above in connection with FIG. 6. If not all non-required system information messages 618b can be obtained before a particular time or before losing a paging message context, the wireless communication device 602 may respond 708 to the communication event(s) (e.g., paging message(s)) before all non-required system information messages 618b. However, if all non-required system information messages 618b can be obtained before a particular time or before losing a paging message context, the wireless communication device 602 may respond 708 to the communication event(s) (e.g., paging message(s)) after all non-required system information messages 618b are obtained.

Responding 708 to the communication event(s) may include one or more of the following procedures for receiving payload information from and/or transmitting payload information to the network (e.g., cell B 610b). In some configurations, responding 708 to the communication event(s) includes initiating a random access procedure (with cell B 610b, for instance). For example, responding 708 to the communication event(s) may include initiating a RACH procedure. Initiating the random access procedure may include sending a random access request (to cell B 610b, for example).

The wireless communication device 602 may abandon 710 reading (e.g., receiving and/or decoding) any other system information message 618 (e.g., non-required system information message 618b). This may be accomplished as described above in connection with one or more of FIGS. 1-3 and 5-6. For example, the wireless communication device 602 may abandon 710 reading any remaining non-required system information message 618b upon obtaining the at least one system information message 618 required to respond to the communication event.

In some configurations, the wireless communication device 602 may determine whether to abandon 710 reading any remaining non-required system information message(s) 618b. For example, the wireless communication device 602 may make this determination based on one or more factors. This may be accomplished as described above in connection with FIG. 6.

Abandoning 710 reading any other system information message 618 may include directing the transceiver 608 to stop receiving any other system information message 618. For example, the wireless communication device 602 may cause the transceiver 608 (by sending an indicator or directive to the transceiver 608, for example) to de-tune from the broadcast channel of cell B 610b. Additionally or alternatively, abandoning reading any other system information message 618 may include discontinuing decoding any other system information message 618.

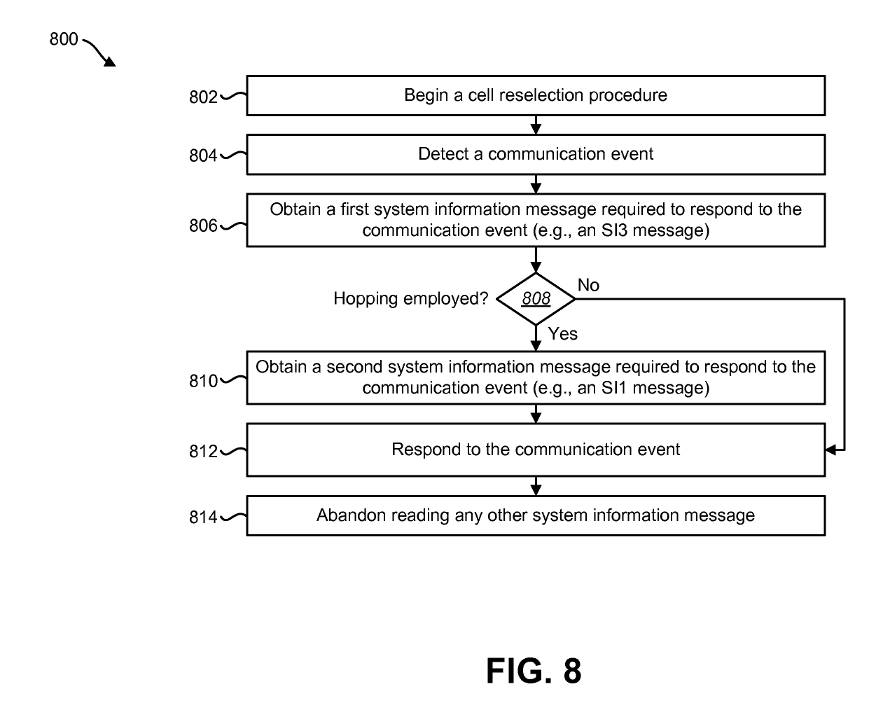

FIG. 8 is a flow diagram illustrating another more specific configuration of a method 800 for responding to a communication event. The method 800 may be performed by the wireless communication device 602. The wireless communication device 602 may begin 802 a cell reselection procedure. This may be accomplished as described above in connection with one or more of FIGS. 1-3 and 5-7.

The wireless communication device 602 may detect 804 one or more communication events. This may be accomplished as described above in connection with one or more of FIGS. 1-3 and 5-7. In some configurations, the wireless communication device 602 may determine whether it 602 is currently in page reorganization mode. If the wireless communication device 602 is not in page reorganization mode, it 602 may respond to the communication event (e.g., paging message) normally. If the wireless communication device 602 is in page reorganization mode (when the one or more communication events are detected), it 602 may prioritize responding to the communication event(s) as described herein.

The wireless communication device 602 may obtain 806 a first system information message required to respond to the communication event. For example, the wireless communication device 602 may obtain 806 an SI3 message. This may be accomplished as described above in connection with one or more of FIGS. 1-3 and 5-7.

The wireless communication device 602 may determine 808 whether hopping is employed. For example, the wireless communication device 602 may determine 808 whether hopping is employed by the wireless communication system 600 and/or network (e.g., cell A 610a and/or cell B 610b). In some configurations, this determination 808 may be based on a message received from one or more cells (e.g., cell A 610a and/or cell B 610b) and/or based on a predetermined indicator (e.g., data stored on the wireless communication device 602). For example, the wireless communication device 602 may receive a system information message 618 indicating whether hopping is employed by the network.

If hopping is not employed, the wireless communication device 602 may respond 812 to the communication event(s). This may be accomplished as described above in connection with one or more of FIGS. 1-3 and 5-7. For example, the wireless communication device 602 may respond 812 to the communication event(s) before all system information messages 618 (e.g., before all non-required system information messages 618b) are obtained. Alternatively, the wireless communication device 602 may respond 812 to the communication event(s) based on one or more factors as described above in connection with one or more of FIGS. 6-7.

The wireless communication device 602 may abandon 814 reading (e.g., receiving and/or decoding) any other system information message 618 (e.g., non-required system information message 618b). This may be accomplished as described above in connection with one or more of FIGS. 1-3 and 5-7. For example, the wireless communication device 602 may abandon 814 reading any remaining non-required system information message 618b upon obtaining the at least one system information message 618 required to respond to the communication event. Alternatively, the wireless communication device 602 may abandon 814 reading any other system information message (e.g., non-required system information message 618b) based on one or more factors as described above in connection with one or more of FIGS. 6-7.

If the wireless communication device 602 determines 808 that hopping is employed, the wireless communication device 602 may obtain 810 a second system information message required to respond to the communication event. For example, the wireless communication device 602 may obtain 810 an SI1 message. This may be accomplished as described above in connection with one or more of FIGS. 1-3 and 5-7. The wireless communication device 602 may respond 812 to the communication event and/or abandon 814 reading any other system information message as described above.

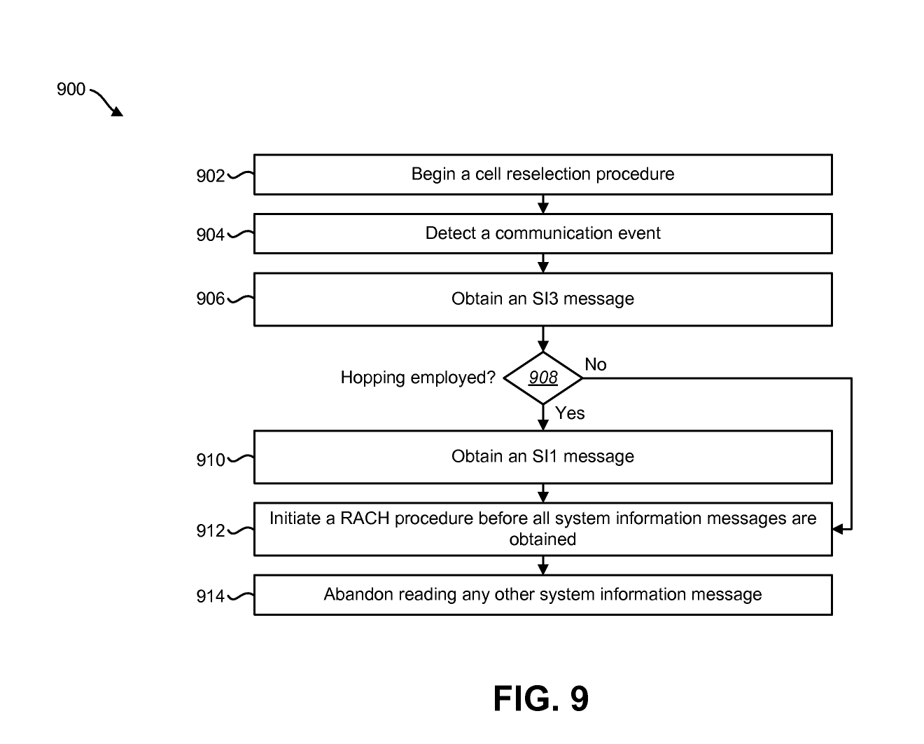

FIG. 9 is a flow diagram illustrating another more specific configuration of a method 900 for responding to a communication event. The method 900 may be performed by the wireless communication device 602. The wireless communication device 602 may begin 902 a cell reselection procedure. This may be accomplished as described above in connection with one or more of FIGS. 1-3 and 5-8.

The wireless communication device 602 may detect 904 one or more communication events. This may be accomplished as described above in connection with one or more of FIGS. 1-3 and 5-8.

The wireless communication device 602 may obtain 906 an SI3 message. This may be accomplished as described above in connection with one or more of FIGS. 1-3 and 5-8.

The wireless communication device 602 may determine 908 whether hopping is employed. This may be accomplished as described above in connection with FIG. 8. For example, the wireless communication device 602 may determine 908 whether hopping is employed based on a message received from one or more cells and/or based on a predetermined indicator.

If hopping is not employed, the wireless communication device 602 may initiate 912 a RACH procedure. For example, the wireless communication device 602 may initiate 912 a RACH procedure before all system information messages 618 (e.g., non-required system information messages 618b) are obtained. This may be accomplished as described above in connection with one or more of FIGS. 1-3 and 5-8.

The wireless communication device 602 may abandon 914 reading (e.g., receiving and/or decoding) any other system information message 618 (e.g., non-required system information message 618b). This may be accomplished as described above in connection with one or more of FIGS. 1-3 and 5-8.

If the wireless communication device 602 determines 908 that hopping is employed, the wireless communication device 602 may obtain 910 an SI1 message. This may be accomplished as described above in connection with one or more of FIGS. 1-3 and 5-8. The wireless communication device 602 may initiate 912 a RACH procedure before all system information messages are obtained and/or may abandon 914 reading any other system information message 618 as described above.

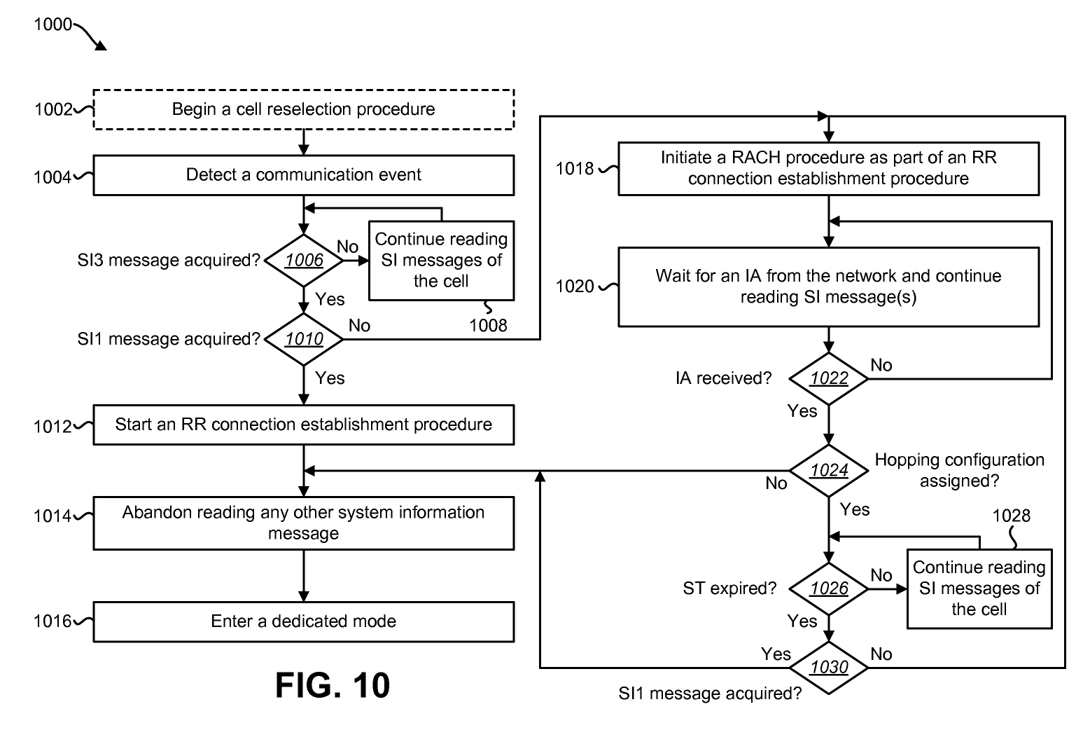

FIG. 10 is a flow diagram illustrating another more specific configuration of a method 1000 for responding to a communication event. The method 900 may be performed by one or more of the wireless communication devices 102,302,502,602 described herein. The wireless communication device 602 may optionally begin 1002 a cell reselection procedure. This may be accomplished as described above in connection with one or more of FIGS. 1-3 and 5-9.

The wireless communication device 602 may detect 1004 a communication event. This may be accomplished as described above in connection with one or more of FIGS. 1-3 and 5-9. For example, the wireless communication device 602 may obtain a paging message, may detect a mobile originating (MO) call establishment and/or may detect a mobile terminating (MT) call establishment. The MO call establishment may occur in a GSM system due to circuit-switched fallback (CSFB). Additionally or alternatively, the MT call establishment may occur in a GSM system due to circuit-switched fallback (CSFB).

The wireless communication device 602 may determine 1006 whether an SI3 message has been acquired. For example, the wireless communication device 602 may determine whether an SI3 message has been read (e.g., received and/or decoded) as described above in connection with one or more of FIGS. 1-3 and 5-9. For instance, the wireless communication device 602 may determine if a received signal (broadcast from a cell, for example) explicitly or implicitly indicates that it includes an SI3 message. In some configurations, the signal may include an explicit indicator that indicates an SI3 message. In other configurations, the wireless communication device 602 may determine that the signal includes an SI3 message based on an implicit indicator (e.g., the resources used to send the signal, the timing of the signal, the structure of the signal, a code used to descramble the signal, etc.). If an SI3 message has not been acquired, the wireless communication device 602 may continue reading 1008 one or more SI messages 618 of the cell (e.g., cell B 610b). This may be done until an SI3 message is acquired, for example.

If an SI3 message is acquired, the wireless communication device 602 may determine 1010 whether an SI1 message has been acquired. For example, the wireless communication device 602 may determine 1010 whether an SI1 message has been read (e.g., received and/or decoded) as described above in connection with one or more of FIGS. 1-3 and 5-9. For instance, the wireless communication device 602 may determine if a received signal (broadcast from a cell, for example) explicitly or implicitly indicates that it includes an SI1 message. In some configurations, the signal may include an explicit indicator that indicates an SI1 message. In other configurations, the wireless communication device 602 may determine that the signal includes an SI1 message based on an implicit indicator (e.g., the resources used to send the signal, the timing of the signal, the structure of the signal, a code used to descramble the signal, etc.).

If the SI1 message has been acquired, the wireless communication device 602 may start 1012 a radio resource (RR) connection establishment procedure. In some configurations, the wireless communication device 602 may perform one or more of the following steps as part of RR connection establishment procedure. The wireless communication device 602 (e.g., UE) may send a channel request message to the network (e.g., cell B 610b) via the RACH channel on the uplink. The wireless communication device 602 may then read the access grant channel (AGCH) on the downlink for a potential radio assignment message (e.g., IMMEDIATE ASSIGNMENT, etc.) from the network. This assignment message may provide the necessary information to the wireless communication device 602 regarding the dedicated channel(s) assigned to the wireless communication device 602. A subsequent higher layer message exchange may occur on the dedicated channel(s) assigned to the wireless communication device 602. After the wireless communication device 602 successfully latches onto the radio resources assigned, the wireless communication device 602 may enter 1016 a dedicated mode.

The wireless communication device 602 may abandon 1014 reading (e.g., receiving and/or decoding) any other system information message 618 (e.g., non-required system information message 618b). This may be accomplished as described above in connection with one or more of FIGS. 1-3 and 5-9. The wireless communication device 602 may enter 1016 a dedicated mode. It should be noted that entering 1016 the dedicated mode may be performed before, during or after abandoning 1014 reading any other system information message.

If the wireless communication device 602 determines 1010 that an SI1 message has not been acquired, the wireless communication device 602 may initiate 1018 a RACH procedure as part of an RR connection establishment procedure. This may be accomplished as described above in connection with one or more of FIGS. 1-3 and 5-9. For example, the wireless communication device 602 may send a random access request (to cell B 610b, for instance).

The wireless communication device 602 may wait 1020 for an immediate assignment (IA) from the network (e.g., from cell B 610b) and continue reading one or more SI messages. For example, the wireless communication device 602 may read one or more SI messages while waiting to receive (e.g., in parallel with receiving) an IA. The IA may assign communication resources (e.g., time and/or frequency resources) to the wireless communication device 602 for communications (e.g., a phone call, text message, data download, etc.).

The wireless communication device 602 may determine 1022 whether an IA has been received. For example, the wireless communication device 602 may determine whether a cell (e.g., cell B 610b) has sent an IA in response to initiating 1018 the RACH procedure. If an IA has not been received, the wireless communication device 602 may continue waiting 1020 for an IA and reading SI message(s).

If an IA has been received, the wireless communication device 602 may determine 1024 whether a hopping configuration is assigned. For example, the wireless communication device 602 may check the content of an assignment message to determine if a hopping configuration is received. In some configurations, the wireless communication device 602 may read the access grant channel (AGCH) on the downlink for a potential radio assignment message (e.g., IMMEDIATE ASSIGNMENT, etc.) from the network (e.g., Cell B 610b). This may occur as part of the RR connection establishment procedure. There may be an information element in the assignment message called “Channel Description.” Upon decoding this information, the wireless communication device 602 (e.g., UE) may know whether a hopping configuration is assigned. If a hopping configuration is not assigned, the wireless communication device 602 may abandon 1014 reading any other system information message and/or may enter 1016 a dedicated mode as described above.

If a hopping configuration is assigned, the wireless communication device 602 may determine 1026 whether a start time (e.g., “Starttime” or ST) has expired. For example, Starttime may be provided in an assignment message to instruct the wireless communication device 602 (e.g., mobile station) to start using the assigned channel(s) after the expiry of “Starttime.” The wireless communication device 602 (e.g., mobile station) may wait up to the starting time before accessing the channel(s) assigned in the assignment message. In other words, “Starttime” may be an activation time for the channels assigned to the wireless communication device 602 (e.g., UE).

If the ST has not expired, the wireless communication device 602 may continue reading 1028 one or more SI messages 618 of the cell (e.g., cell B 610b). For example, the wireless communication device 602 may continue reading 1028 the SI message(s) until the ST expires.

If ST has expired, the wireless communication device 602 may determine 1030 whether an SI1 message has been acquired. For example, the wireless communication device 602 may determine whether an SI1 message has been read (e.g., received and/or decoded). This may be accomplished as described above. If an SI1 message has not been acquired, the wireless communication device 602 may return to initiate 1018 a RACH procedure as part of an RR connection establishment procedure. If an SI1 message has been acquired, the wireless communication device 602 may abandon 1014 reading any other system information message and/or may enter 1016 a dedicated mode as described above.

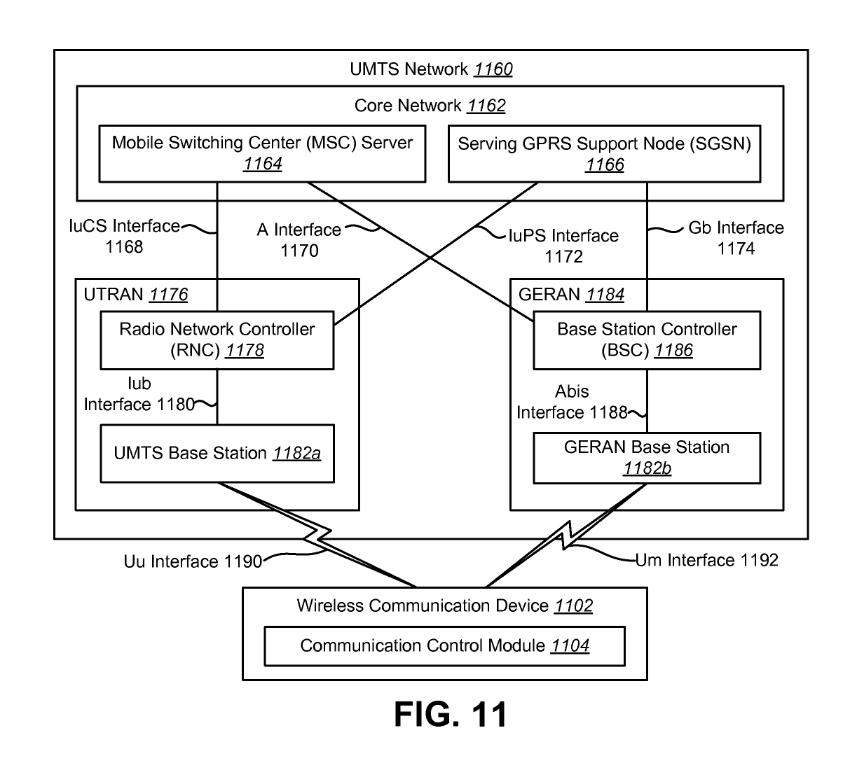

FIG. 11 is a block diagram illustrating a UMTS network 1160 operating according to the systems and methods described herein. The UMTS network 1160 may be used to respond to one or more communication events as described in connection with one or more of FIGS. 1-3 and 5-10. In one configuration, the UMTS network 1160 may include a UMTS radio access network (UTRAN) 1176, which may operate according to UMTS standards.

The UTRAN 1176 may include one or more UMTS base stations 1182a and the control equipment for the UMTS base stations 1182a (e.g., one or more radio network controllers (RNCs) 1178). The UTRAN 1176 provides an air interface access method for the wireless communication device 1102. Connectivity is provided between the wireless communication device 1102 and a core network 1162 by the UTRAN 1176. The core network 1162 may include a mobile switching center (MSC) server 1164 and a serving general packet radio service (GPRS) support node (SGSN) 1166. The MSC server 1164 may provide circuit switched (CS) services (e.g., voice calls), while the SGSN 1166 may provide packet switched (PS) services (e.g., data).

The UTRAN 1176 is connected internally or externally to other functional entities by various interfaces. The UTRAN 1176 is attached to the MSC server 1164 in the core network 1162 via an IuCS interface 1168. The UTRAN 1176 is attached to the SGSN 1166 via an IuPS interface 1172. The RNCs 1178 support these interfaces. In addition, the RNCs 1178 manage a set of UMTS base stations 1182a through Iub interfaces 1180. The Uu interface 1190 connects a UMTS base station 1182a with the wireless communication device 1102. In one configuration, the wireless communication device 1102 may include a communication control module 1104, which may be one example of one or more of the communication control modules 104, 604 described in connection with one or more of FIGS. 1 and 6. The wireless communication device 1102 may communicate with one or more UMTS base stations 1182a via a UMTS access stratum (AS).

The UMTS network 1160 may also include a GSM EDGE Radio Access Network (GERAN) 1184, which may operate according to Global System for Mobile Communications (GSM) standards. The GERAN 1184 may include one or more GERAN base stations 1182b and the control equipment for the GERAN base stations 1182b (e.g., one or more base station controllers (BSCs) 1186). The GERAN 1184 provides an air interface access method for the wireless communication device 1102. Connectivity may be provided between the wireless communication device 1102 and the core network 1162 by the GERAN 1184.

The GERAN 1184 is attached to the MSC server 1164 in the core network 1162 via an A interface 1170. The GERAN 1184 is attached to the SGSN 1166 via a Gb interface 1174. The base station controllers (BSCs) 1186 support these interfaces. In addition, the BSCs 1186 manage a set of GERAN base stations 1182b through Abis interfaces 1188. The Um interface 1192 connects a GERAN base station 1182b with the wireless communication device 1102. In one configuration, the wireless communication device 1102 may communicate with one or more GERAN base stations 1182b via a GERAN access stratum (AS).

The UMTS network 1160 may be further connected to additional networks outside the UMTS network 1160, such as a corporate intranet, the Internet, or a conventional public switched telephone network (not shown). The UMTS network 1160 may transport data packets between each wireless communication device 1102 and such outside networks.

The wireless communication device 1102 may be camped on cell A 110a provided by one or more of the UMTS base stations 1182a and/or one or more of the GERAN base stations 1182b. The wireless communication device 1102 may initiate a cell reselection to cell B 110b provided by one or more of the UMTS base stations 1182a and/or the GERAN base stations 1182b. The wireless communication device 1102 may respond to a communication event as described in connection with one or more of FIGS. 1-3 and 5-10.

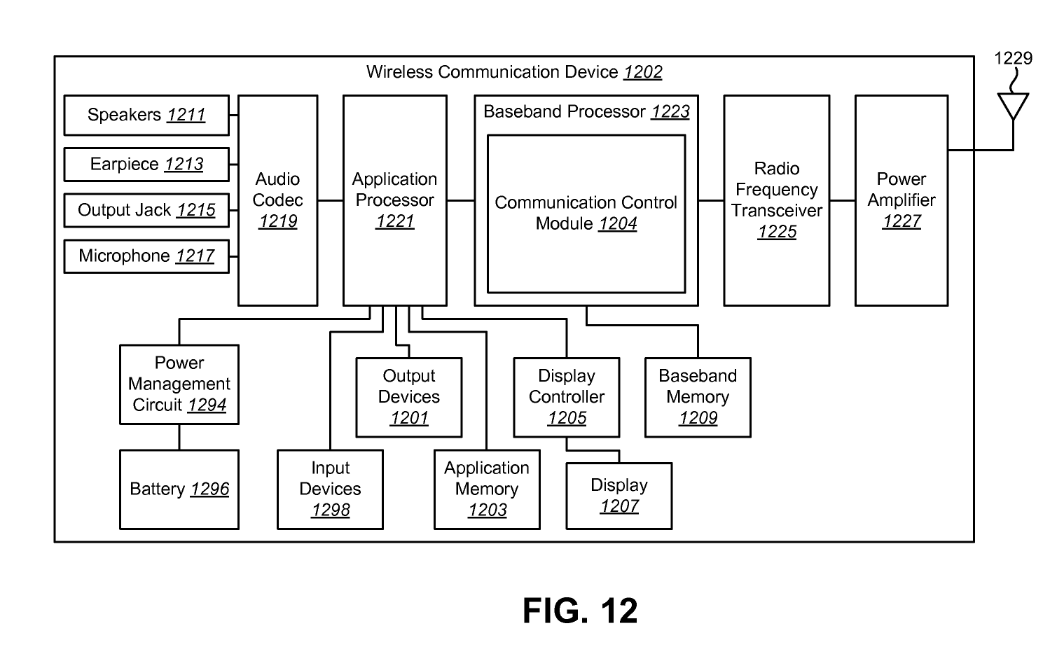

FIG. 12 is a block diagram illustrating another more specific configuration of a wireless communication device 1202 in which systems and methods for responding to a communication event may be implemented. The wireless communication device 1202 illustrated in FIG. 12 may be an example of one or more of the wireless communication devices 102, 302, 502, 602, 1102 described herein. The wireless communication device 1202 may include an application processor 1221. The application processor 1221 generally processes instructions (e.g., runs programs) to perform functions on the wireless communication device 1202. The application processor 1221 may be coupled to an audio coder/decoder (codec) 1219.

The audio codec 1219 may be used for coding and/or decoding audio signals. The audio codec 1219 may be coupled to at least one speaker 1211, an earpiece 1213, an output jack 1215 and/or at least one microphone 1217. The speakers 1211 may include one or more electro-acoustic transducers that convert electrical or electronic signals into acoustic signals. For example, the speakers 1211 may be used to play music or output a speakerphone conversation, etc. The earpiece 1213 may be another speaker or electro-acoustic transducer that can be used to output acoustic signals (e.g., speech signals) to a user. For example, the earpiece 1213 may be used such that only a user may reliably hear the acoustic signal. The output jack 1215 may be used for coupling other devices to the wireless communication device 1202 for outputting audio, such as headphones. The speakers 1211, earpiece 1213 and/or output jack 1215 may generally be used for outputting an audio signal from the audio codec 1219. The at least one microphone 1217 may be an acousto-electric transducer that converts an acoustic signal (such as a user's voice) into electrical or electronic signals that are provided to the audio codec 1219.

The application processor 1221 may also be coupled to a power management circuit 1294. One example of a power management circuit 1294 is a power management integrated circuit (PMIC), which may be used to manage the electrical power consumption of the wireless communication device 1202. The power management circuit 1294 may be coupled to a battery 1296. The battery 1296 may generally provide electrical power to the wireless communication device 1202. For example, the battery 1296 and/or the power management circuit 1294 may be coupled to at least one of the elements included in the wireless communication device 1202.

The application processor 1221 may be coupled to at least one input device 1298 for receiving input. Examples of input devices 1298 include infrared sensors, image sensors, accelerometers, touch sensors, keypads, etc. The input devices 1298 may allow user interaction with the wireless communication device 1202. The application processor 1221 may also be coupled to one or more output devices 1201. Examples of output devices 1201 include printers, projectors, screens, haptic devices, etc. The output devices 1201 may allow the wireless communication device 1202 to produce output that may be experienced by a user.

The application processor 1221 may be coupled to application memory 1203. The application memory 1203 may be any electronic device that is capable of storing electronic information. Examples of application memory 1203 include double data rate synchronous dynamic random access memory (DDRAM), synchronous dynamic random access memory (SDRAM), flash memory, etc. The application memory 1203 may provide storage for the application processor 1221. For instance, the application memory 1203 may store data and/or instructions for the functioning of programs that are run on the application processor 1221.

The application processor 1221 may be coupled to a display controller 1205, which in turn may be coupled to a display 1207. The display controller 1205 may be a hardware block that is used to generate images on the display 1207. For example, the display controller 1205 may translate instructions and/or data from the application processor 1221 into images that can be presented on the display 1207. Examples of the display 1207 include liquid crystal display (LCD) panels, light emitting diode (LED) panels, cathode ray tube (CRT) displays, plasma displays, etc.

The application processor 1221 may be coupled to a baseband processor 1223. The baseband processor 1223 generally processes communication signals. For example, the baseband processor 1223 may demodulate and/or decode received signals. Additionally or alternatively, the baseband processor 1223 may encode and/or modulate signals in preparation for transmission.

The baseband processor 1223 may include a communication control module 1204. The communication control module 1204 may be an example of one or more of the communication control modules 104, 604, 1104 described above. In some configurations, the communication control module 1204 may be implemented on the wireless communication device 1202 separately from the baseband processor 1223.

The baseband processor 1223 may be coupled to baseband memory 1209. The baseband memory 1209 may be any electronic device capable of storing electronic information, such as SDRAM, DDRAM, flash memory, etc. The baseband processor 1223 may read information (e.g., instructions and/or data) from and/or write information to the baseband memory 1209. Additionally or alternatively, the baseband processor 1223 may use instructions and/or data stored in the baseband memory 1209 to perform communication operations.

The baseband processor 1223 may be coupled to a radio frequency (RF) transceiver 1225. The RF transceiver 1225 may be coupled to a power amplifier 1227 and one or more antennas 1229. The RF transceiver 1225 may transmit and/or receive radio frequency signals. For example, the RF transceiver 1225 may transmit an RF signal using a power amplifier 1227 and at least one antenna 1229. The RF transceiver 1225 may also receive RF signals using the one or more antennas 1229.

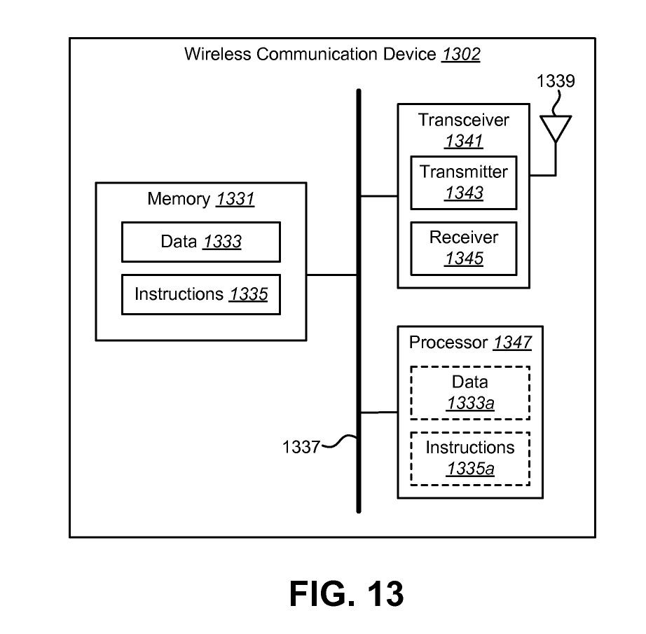

FIG. 13 illustrates certain components that may be included within a wireless communication device 1302. The wireless communication device 1302 described in connection with FIG. 13 may be an example of and/or may be implemented in accordance with one or more of the wireless communication devices 102, 302, 502, 602, 1102, 1202 described in connection with one or more of FIGS. 1-3 and 5-12.

The wireless communication device 1302 includes a processor 1347. The processor 1347 may be a general purpose single- or multi-chip microprocessor (e.g., an ARM), a special purpose microprocessor (e.g., a digital signal processor (DSP)), a microcontroller, a programmable gate array, etc. The processor 1347 may be referred to as a central processing unit (CPU). Although just a single processor 1347 is shown in the wireless communication device 1302 of FIG. 13, in an alternative configuration, a combination of processors (e.g., an ARM and DSP) could be used.

The wireless communication device 1302 also includes memory 1331 in electronic communication with the processor 1347 (i.e., the processor 1347 can read information from and/or write information to the memory 1331). The memory 1331 may be any electronic component capable of storing electronic information. The memory 1331 may be random access memory (RAM), read-only memory (ROM), magnetic disk storage media, optical storage media, flash memory devices in RAM, on-board memory included with the processor, programmable read-only memory (PROM), erasable programmable read-only memory (EPROM), electrically erasable PROM (EEPROM), registers, and so forth, including combinations thereof.

Data 1333 and instructions 1335 may be stored in the memory 1331. The instructions 1335 may include one or more programs, routines, sub-routines, functions, procedures, code, etc. The instructions 1335 may include a single computer-readable statement or many computer-readable statements. The instructions 1335 may be executable by the processor 1347 to implement one or more of the methods 200, 700, 800, 900, 1000 described above. Executing the instructions 1335 may involve the use of the data 1333 that is stored in the memory 1331. FIG. 13 shows some instructions 1335a and data 1333a being loaded into the processor 1347.

The wireless communication device 1302 may also include a transmitter 1343 and a receiver 1345 to allow transmission and reception of signals between the wireless communication device 1302 and a remote location (e.g., a base station). The transmitter 1343 and receiver 1345 may be collectively referred to as a transceiver 1341. An antenna 1339 may be electrically coupled to the transceiver 1341. The wireless communication device 1302 may also include (not shown) multiple transmitters, multiple receivers, multiple transceivers and/or multiple antenna.

The various components of the wireless communication device 1302 may be coupled together by one or more buses, which may include a power bus, a control signal bus, a status signal bus, a data bus, etc. For simplicity, the various buses are illustrated in FIG. 13 as a bus system 1337.

The techniques described herein may be used for various communication systems, including communication systems that are based on an orthogonal multiplexing scheme. Examples of such communication systems include Orthogonal Frequency Division Multiple Access (OFDMA) systems, Single-Carrier Frequency Division Multiple Access (SC-FDMA) systems, and so forth. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

In the above description, reference numbers have sometimes been used in connection with various terms. Where a term is used in connection with a reference number, this may be meant to refer to a specific element that is shown in one or more of the Figures. Where a term is used without a reference number, this may be meant to refer generally to the term without limitation to any particular Figure.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

It should be noted that one or more of the features, functions, procedures, components, elements, structures, etc., described in connection with any one of the configurations described herein may be combined with one or more of the functions, procedures, components, elements, structures, etc., described in connection with any of the other configurations described herein, where compatible. In other words, any compatible combination of the functions, procedures, components, elements, etc., described herein may be implemented in accordance with the systems and methods disclosed herein.

The functions described herein may be stored as one or more instructions on a processor-readable or computer-readable medium. The term “computer-readable medium” refers to any available medium that can be accessed by a computer or processor. By way of example, and not limitation, such a medium may comprise Random-Access Memory (RAM), Read-Only Memory (ROM), Electrically Erasable Programmable Read-Only Memory (EEPROM), flash memory, Compact Disc Read-Only Memory (CD-ROM) or other optical disk storage, magnetic disk storage or other magnetic storage devices, or any other medium that can be used to store desired program code in the form of instructions or data structures and that can be accessed by a computer. Disk and disc, as used herein, includes compact disc (CD), laser disc, optical disc, digital versatile disc (DVD), floppy disk and Blu-ray® disc, where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

1. A method for responding to a communication event by a wireless communication device, comprising:
beginning a cell reselection procedure;
detecting a communication event;
obtaining at least one system information message required to respond to the communication event; and
responding to the communication event before all system information messages are obtained.

2. The method of claim 1, further comprising abandoning reading any other system information message upon obtaining the at least one system information message required to respond to the communication event.

3. The method of claim 1, wherein the at least one system information message required to respond to the communication event includes Random Access Channel (RACH) control parameters.

4. The method of claim 3, wherein responding to the communication event comprises initiating a RACH procedure.

5. The method of claim 1, wherein the at least one system information message required to respond to the communication event comprises an SI3 message.

6. The method of claim 1, wherein the at least one system information message required to respond to the communication event comprises an SI3 message and an SI1 message when hopping is employed.

7. The method of claim 1, wherein the communication event is detected during the cell reselection procedure.

8. The method of claim 1, wherein the communication event comprises at least one of receiving a paging message, initiating mobile terminating (MT) call establishment and initiating mobile originating (MO) call establishment.

9. A wireless communication device for responding to a communication event, comprising:
cell reselection circuitry, wherein the cell reselection circuitry is configured to begin a cell reselection procedure, detect a communication event, and obtain at least one system information message required to respond to the communication event; and
prioritized response circuitry coupled to the cell reselection circuitry, wherein the prioritized response circuitry is configured to respond to the communication event before all system information messages are obtained.

10. The wireless communication device of claim 9, wherein the cell reselection circuitry is configured to abandon reading any other system information message upon obtaining the at least one system information message required to respond to the communication event.

11. The wireless communication device of claim 9, wherein the at least one system information message required to respond to the communication event includes Random Access Channel (RACH) control parameters.

12. The wireless communication device of claim 11, wherein responding to the communication event comprises initiating a RACH procedure.

13. The wireless communication device of claim 9, wherein the at least one system information message required to respond to the communication event comprises an SI3 message.

14. The wireless communication device of claim 9, wherein the at least one system information message required to respond to the communication event comprises an SI3 message and an SI1 message when hopping is employed.

15. The wireless communication device of claim 9, wherein the cell reselection circuitry is configured to detect the communication event during the cell reselection procedure.

16. The wireless communication device of claim 9, wherein the communication event comprises at least one of receiving a paging message, initiating mobile terminating (MT) call establishment and initiating mobile originating (MO) call establishment.

17. A computer-program product for responding to a communication event, comprising a non-transitory tangible computer-readable medium having instructions thereon, the instructions comprising:
code for causing a wireless communication device to begin a cell reselection procedure;
code for causing the wireless communication device to detect a communication event;
code for causing the wireless communication device to obtain at least one system information message required to respond to the communication event; and
code for causing the wireless communication device to respond to the communication event before all system information messages are obtained.

18. The computer-program product of claim 17, the instructions further comprising code for causing the wireless communication device to abandon reading any other system information message upon obtaining the at least one system information message required to respond to the communication event.

19. The computer-program product of claim 17, wherein the at least one system information message required to respond to the communication event includes Random Access Channel (RACH) control parameters.

20. The computer-program product of claim 19, wherein responding to the communication event comprises initiating a RACH procedure.

21. The computer-program product of claim 17, wherein the at least one system information message required to respond to the communication event comprises an SI3 message.

22. The computer-program product of claim 17, wherein the at least one system information message required to respond to the communication event comprises an SI3 message and an SI1 message when hopping is employed.

23. The computer-program product of claim 17, wherein the communication event is detected during the cell reselection procedure.

24. An apparatus for responding to a communication event, comprising:
means for beginning a cell reselection procedure;
means for detecting a communication event;
means for obtaining at least one system information message required to respond to the communication event; and
means for responding to the communication event before all system information messages are obtained.

25. The apparatus of claim 24, further comprising means for abandoning reading any other system information message upon obtaining the at least one system information message required to respond to the communication event.

26. The apparatus of claim 24, wherein the at least one system information message required to respond to the communication event includes Random Access Channel (RACH) control parameters.

27. The apparatus of claim 26, wherein responding to the communication event comprises initiating a RACH procedure.

28. The apparatus of claim 24, wherein the at least one system information message required to respond to the communication event comprises an SI3 message.

29. The apparatus of claim 24, wherein the at least one system information message required to respond to the communication event comprises an SI3 message and an SI1 message when hopping is employed.

30. The apparatus of claim 24, wherein the communication event is detected during the cell reselection procedure.
